(19) United States
(12) Patent Application Publication
(10) Pub. No.: US 2026/0339393 A1
(43) Pub. Date: Oct. 29, 2026

(54) WEARABLE ELECTRONIC DEVICE AND CONTROL METHOD OF WEARABLE ELECTRONIC DEVICE

(71) Applicant: Samsung Electronics Co., Ltd., Suwon-si (KR)

(72) Inventors: Nina LEE, Suwon-si (KR); Dongil SON, Suwon-si (KR)

(21) Appl. No.: 19/705,223

(22) Filed: Jun. 11, 2026

Related U.S. Application Data
(63) Continuation of application No. PCT/KR2025/099034, filed on Jan. 16, 2025.

(30) Foreign Application Priority Data
Jan. 31, 2024 (KR) 10-2024-0014865
Mar. 14, 2024 (KR) 10-2024-0035789

(51) Int. Cl. G06F 1/16

(52) U.S. Cl. CPC G06F 1/1641; G06F 1/163

(57) ABSTRACT

A wearable electronic device is provided. The wearable electronic device includes a sensor, a display including a first display area and a second display area, memory including one or more storage media storing instructions, and at least one processor including processing circuitry communicatively coupled to the sensor, the display, and the memory, wherein the instructions, when executed by the processor individually or collectively, cause the wearable electronic device to display a first multilayer having a first size, in which a first layer corresponding to a first unidentified notification and a second layer corresponding to a second unidentified notification at least partially overlap, in the second display area, and transform the first multilayer into a second multilayer having a second size based on detecting the wearable electronic device rotating in a first direction, by using the sensor, and change a display area of at least one layer among the second multilayer from the second display area to the first display area and display the changed display area.

### CROSS-REFERENCE TO RELATED APPLICATION(S)

This application is a continuation application, claiming priority under 35 U.S.C. § 365(c), of an International application No. PCT/KR2025/099034, filed on Jan. 16, 2025, which is based on and claims the benefit of a Korean patent application number 10-2024-0014865, filed on Jan. 31, 2024, in the Ministry of Intellectual Property (MOIP), and of a Korean patent application number 10-2024-0035789, filed on Mar. 14, 2024, in the Ministry of Intellectual Property (MOIP), the disclosure of each of which is incorporated by reference herein in its entirety.

### BACKGROUND

### 1. Field

The disclosure relates to a wearable electronic device and a method for controlling the wearable electronic device.

### 2. Description of Related Art

There has been increasing use of wearable electronic devices (e.g., watches) that can be worn on the user's body (e.g., wrists), and wearable electronic devices have been provided with various functions.

The wearable electronic devices may be coupled to or separated from a part of the user's body by using a strap.

The wearable electronic devices may interact with other electronic devices (e.g., smartphones) to provide various services to the user.

The above information is presented as background information only to assist with an understanding of the disclosure. No determination has been made, and no assertion is made, as to whether any of the above might be applicable as prior art with regard to the disclosure.

### SUMMARY

A wearable electronic device (e.g., a watch) may be paired with an electronic device (e.g., a smartphone) and may display various pieces of information provided from the electronic device on the display.

For example, as the user swipes to the right while touching the display, the wearable electronic device may display notifications received through a designated application with regard to each layer (e.g., page). For example, as the user swipes to the left while touching the display, the wearable electronic device may display a user-configured widget with regard to each layer (e.g., page).

In order to identify desired information among notifications received through the designated application and the configured widget, the user of the wearable electronic device may have to identify each layer (e.g., page) one after one through a swipe to the left or right of the display in an inconvenient manner.

Aspects of the disclosure are to address at least the above-mentioned problems and/or disadvantages and to provide at least the advantages described below. Accordingly, an aspect of the disclosure is to provide a wearable electronic device and a method for controlling the wearable electronic device, wherein based on the direction of rotation of the wrist on which the wearable electronic device is worn, unidentified notifications and/or recommended information may be displayed in a multilayer type (e.g., multi-page or glance view) in the display area of the display corresponding to the user's field of view.

Another aspect of the disclosure is to provide a wearable electronic device and a method for controlling the wearable electronic device, wherein based on the direction of rotation of the wrist on which the wearable electronic device is worn, the display area of at least one of multiple layers including unidentified notifications and/or recommended information is displayed so as to be changed or extended from the first display area of the display to the second display area (e.g., as a glance view).

Additional aspects will be set forth in part in the description which follows and, in part, will be apparent from the description, or may be learned by practice of the presented embodiments.

In accordance with an aspect of the disclosure, a wearable electronic device is provided. The wearable electronic device includes a sensor, a display including a first display area and a second display area, memory including one or more storage media storing instructions, and at least one processor including processing circuitry communicatively coupled to the sensor, the display, and the memory, wherein the instructions, when executed by the at least one processor individually or collectively, cause the wearable electronic device to display a first multilayer having a first size in which a first layer corresponding to a first unidentified notification and a second layer corresponding to a second unidentified notification at least partially overlap, in the second display area, transform the first multilayer into a second multilayer having a second size, based on detecting the wearable electronic device rotating in a first direction, by using the sensor, and change a display area of at least one layer among the second multilayer from the second display area to the first display area and display the changed display area.

In accordance with another aspect of the disclosure, a method for controlling a wearable electronic device is provided. The method includes displaying a first multilayer having a first size in which a first layer corresponding to a first unidentified notification and a second layer corresponding to a second unidentified notification at least partially overlap, in a second display area of a display, identifying the wearable electronic device rotating in a first direction, by using a sensor, transforming the first multilayer into a second multilayer having a second size, based on the wearable electronic device rotating in a first direction, and changing a display area of at least one layer among the second multilayer from the second display area to a first display area and displaying the changed display area.

In accordance with another aspect of the disclosure, one or more non-transitory computer-readable storage media storing one or more computer programs including computer-executable instructions that, when executed by at least one processor of a wearable electronic device individually or collectively, cause the at least one processor to perform operations are provided. The operations include displaying a first multilayer having a first size in which a first layer corresponding to a first unidentified notification and a second layer corresponding to a second unidentified notification at least partially overlap, in a second display area of a display, identifying the wearable electronic device rotating in a first direction, by using a sensor, transforming the first multilayer into a second multilayer having a second size, based on the wearable electronic device rotating in a first direction, and changing a display area of at least one layer among the second multilayer from the second display area to a first display area and displaying the changed display area.

According to an embodiment of the disclosure, the method for controlling a wearable electronic device is performed by using a non-transitory computer-readable recording medium storing one or more programs. The one or more programs according to an embodiment includes instructions and/or commands performed when executed by the processor of the wearable electronic device.

According to various embodiments of the disclosure, based on the direction of rotation of the wrist on which the wearable electronic device is worn, unidentified notifications and/or recommended information is provided in a multilayer type (e.g., multi-page or glance view) in the display area of the display corresponding to the user's field of view such that the user can conveniently identify unidentified notifications and/or recommended information.

Other aspects, advantageous and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1A is a block diagram of an electronic device in a network environment according to an embodiment of the disclosure;

FIG. 1B is a block diagram of a display module according to an embodiment of the disclosure;

FIG. 2A is a schematic diagram of an embodiment in which a wearable electronic device is rotated in a first direction while being worn on a left wrist of a user according to an embodiment of the disclosure;

FIG. 2B is a schematic diagram of an embodiment in which a wearable electronic device is rotated in a first direction while being worn on a right wrist of a user according to an embodiment of the disclosure;

FIG. 3A is a schematic diagram of a first multilayer displayed in a second display area of a display of a wearable electronic device according to an embodiment of the disclosure;

FIG. 3B is a schematic diagram of a second multilayer displayed on a display of a wearable electronic device according to an embodiment of the disclosure;

FIG. 4A is a schematic diagram of an embodiment in which a wearable electronic device is rotated in a second direction while being worn on a left wrist of a user according to an embodiment of the disclosure;

FIG. 4B is a schematic diagram of an embodiment in which a wearable electronic device is rotated in a second direction while being worn on a right wrist of a user according to an embodiment of the disclosure;

FIG. 5A is a schematic diagram of a first multilayer displayed in a first display area of a display of a wearable electronic device according to an embodiment of the disclosure;

FIG. 5B is a schematic diagram of a second multilayer displayed on a display of a wearable electronic device according to an embodiment of the disclosure;

FIG. 6 is a schematic block diagram of a configuration of a wearable electronic device according to an embodiment of the disclosure;

FIG. 7A is a schematic diagram of an embodiment in which, when a wearable electronic device rotates in a first direction, a specific icon is displayed on a display according to an embodiment of the disclosure;

FIG. 7B is a schematic diagram of an embodiment in which, when a wearable electronic device rotates in a second direction, a specific icon is displayed on a display according to an embodiment of the disclosure;

FIG. 8A is a schematic diagram of a first multilayer of a wearable electronic device according to an embodiment of the disclosure;

FIG. 8B is a schematic diagram of a second multilayer transformed based on a wearable electronic device rotating in a second direction according to an embodiment of the disclosure;

FIG. 8C is a schematic diagram of a first multilayer transformed based on a wearable electronic device rotating by a first angle in a first direction according to an embodiment of the disclosure;

FIG. 8D is a schematic diagram of a third multilayer transformed based on a wearable electronic device rotating by a second angle in a first direction according to an embodiment of the disclosure;

FIG. 8E is a schematic diagram of a background image of a wearable electronic device, which is switched based on the wearable electronic device rotating by a third angle in a first direction according to an embodiment of the disclosure;

FIG. 9A is a schematic diagram of a second multilayer displayed on a display, based on a wearable electronic device rotating in a second direction according to an embodiment of the disclosure;

FIG. 9B is a schematic diagram of an embodiment in which an order of layers is changed based on a wearable electronic device rotating from a second direction in a first direction within a second designated time according to an embodiment of the disclosure;

FIG. 9C is a schematic diagram of an embodiment in which layers displayed on a display of a wearable electronic device are changed through a swipe operation according to an embodiment of the disclosure;

FIG. 9D is a schematic diagram of a touch operation on a layer displayed on a display of a wearable electronic device according to an embodiment of the disclosure;

FIG. 10A is a schematic diagram of an embodiment in which a user of a wearable electronic device configures a main application and a main widget according to an embodiment of the disclosure;

FIG. 10B is a schematic diagram of an embodiment in which an order of multilayers is determined based on a degree of importance configured in a wearable electronic device according to an embodiment of the disclosure;

FIG. 10C is a schematic diagram of an embodiment in which a wearable electronic device generates an unidentified notification included in a first application as a single layer according to an embodiment of the disclosure;

FIG. 10D is a schematic diagram of an embodiment in which a wearable electronic device generates an unidentified notification included in a second application as a single layer according to an embodiment of the disclosure;

FIG. 10E is a schematic diagram of an embodiment in which a wearable electronic device displays a layer generated to respond to an unidentified notification of a first application and a layer generated to respond to an unidentified notification of a second application as a multilayer according to an embodiment of the disclosure;

FIG. 11 is a flowchart illustrating a method for controlling a wearable electronic device according to an embodiment of the disclosure; and

FIG. 12 is a flowchart illustrating a method for controlling a wearable electronic device according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

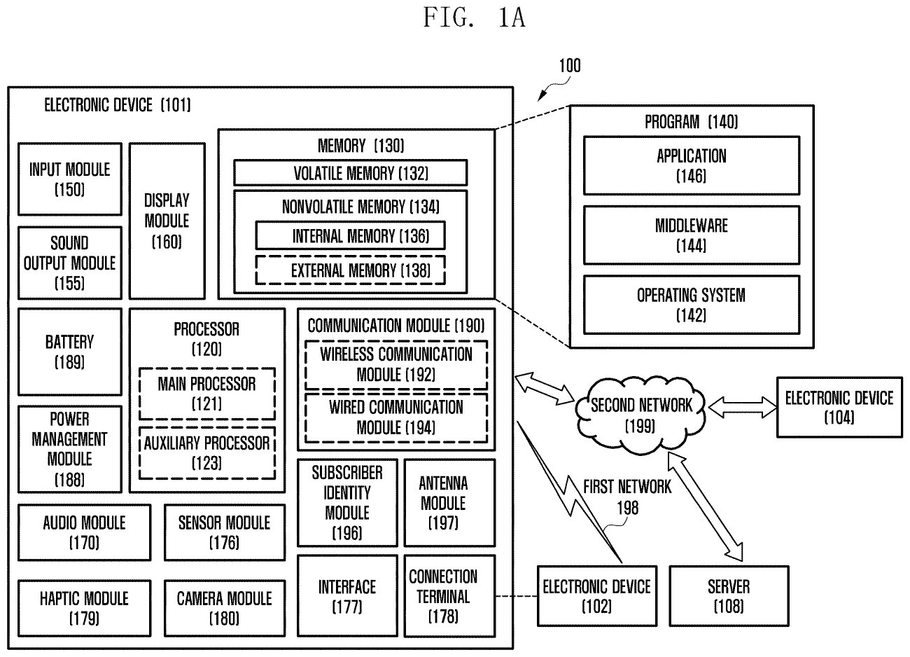

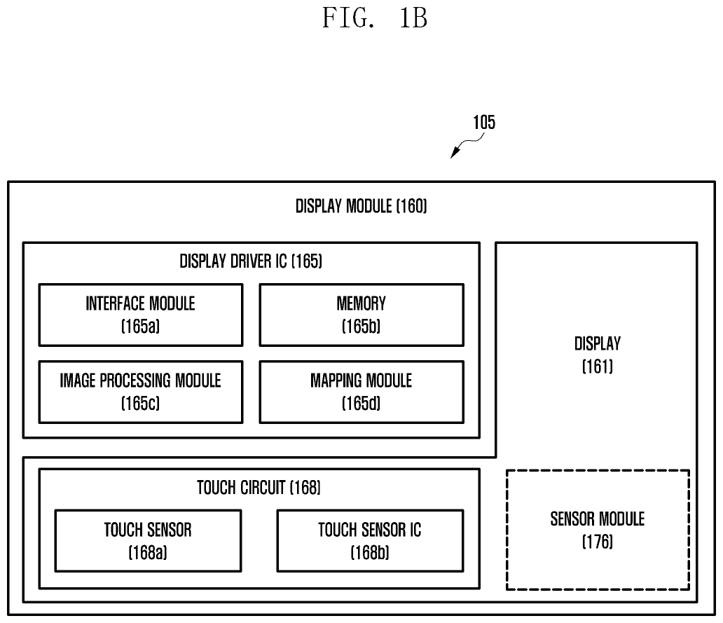

FIG. 1A is a block diagram illustrating an electronic device in a network environment according to an embodiment of the disclosure.

Referring to FIG. 1A, an electronic device 101 in a network environment 100 may communicate with an external electronic device 102 via a first network 198 (e.g., a short-range wireless communication network), or at least one of an external electronic device 104 or a server 108 via a second network 199 (e.g., a long-range wireless communication network). According to an embodiment of the disclosure, the electronic device 101 may communicate with the external electronic device 104 via the server 108. According to an embodiment of the disclosure, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments of the disclosure, at least one of the components (e.g., the connecting terminal 178) may be omitted from the electronic device 101, or one or more other components may be added in the electronic device 101. In some embodiments of the disclosure, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment of the disclosure, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment of the disclosure, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., a sleep) state, or together with the main processor 121 while the main processor 121 is in an active state (e.g., executing an application). According to an embodiment of the disclosure, the auxiliary processor 123 (e.g., an image signal processor or a communication processor) may be implemented as part of another component (e.g., the camera module 180 or the communication module 190) functionally related to the auxiliary processor 123. According to an embodiment of the disclosure, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment of the disclosure, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment of the disclosure, the display module 160 may include a touch sensor adapted to detect a touch, or a pressure sensor adapted to measure the intensity of force incurred by the touch.

The audio module 170 may convert a sound into an electrical signal and vice versa. According to an embodiment of the disclosure, the audio module 170 may obtain the sound via the input module 150, or output the sound via the sound output module 155 or a headphone of an external electronic device (e.g., the external electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment of the disclosure, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the external electronic device 102) directly (e.g., wiredly) or wirelessly. According to an embodiment of the disclosure, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the external electronic device 102). According to an embodiment of the disclosure, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment of the disclosure, the haptic module 179 may include, for example, a motor, a piezoelectric element, or an electric stimulator.

The camera module 180 may capture a still image or moving images. According to an embodiment of the disclosure, the camera module 180 may include one or more lenses, image sensors, image signal processors, or flashes.

The power management module 188 may manage power supplied to the electronic device 101. According to one embodiment of the disclosure, the power management module 188 may be implemented as at least part of, for example, a power management integrated circuit (PMIC).

The battery 189 may supply power to at least one component of the electronic device 101. According to an embodiment of the disclosure, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the external electronic device 102, the external electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment of the disclosure, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a fifth-generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth-generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the external electronic device 104), or a network system (e.g., the second network 199). According to an embodiment of the disclosure, the wireless communication module 192 may support a peak data rate (e.g., 20 Gbps or more) for implementing eMBB, loss coverage (e.g., 164 dB or less) for implementing mMTC, or user plane (U-plane) latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment of the disclosure, the antenna module 197 may include an antenna including a radiating element including a conductive material or a conductive pattern formed in or on a substrate (e.g., a printed circuit board (PCB)). According to an embodiment of the disclosure, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment of the disclosure, another component (e.g., a radio frequency integrated circuit (RFIC)) other than the radiating element may be additionally formed as part of the antenna module 197.

According to various embodiments of the disclosure, the antenna module 197 may form a mmWave antenna module. According to an embodiment of the disclosure, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment of the disclosure, commands or data may be transmitted or received between the electronic device 101 and the external electronic device 104 via the server 108 coupled with the second network 199. Each of the external electronic devices 102 or 104 may be a device of a same type as, or a different type, from the electronic device 101. According to an embodiment of the disclosure, all or some of operations to be executed at the electronic device 101 may be executed at one or more of the external electronic devices 102 or 104, or the server 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment of the disclosure, the external electronic device 104 may include an Internet-of-things (IoT) device. The server 108 may be an intelligent server using machine learning and/or a neural network. According to an embodiment of the disclosure, the external electronic device 104 or the server 108 may be included in the second network 199. The electronic device 101 may be applied to intelligent services (e.g., a smart home, a smart city, a smart car, or healthcare) based on 5G communication technology or IoT-related technology.

FIG. 1B is a block diagram illustrating a display module according to an embodiment of the disclosure.

Referring to FIG. 1B, the display module 160 may include a display 161 and a display driver integrated circuit (DDI) 165 to control the display 161. The DDI 165 may include an interface module 165a, memory 165b (e.g., buffer memory), an image processing module 165c, or a mapping module 165d. The DDI 165 may receive image information that contains image data or an image control signal corresponding to a command to control the image data from another component of the electronic device 101 via the interface module 165a. For example, according to an embodiment of the disclosure, the image information may be received from the processor 120 (e.g., the main processor 121 (e.g., an application processor)) or the auxiliary processor 123 (e.g., a graphics processing unit) operated independently from the function of the main processor 121. The DDI 165 may communicate, for example, with touch circuitry 168 or the sensor module 176 via the interface module 165a. The DDI 165 may also store at least part of the received image information in the memory 165b, for example, on a frame by frame basis. The image processing module 165c may perform pre-processing or post-processing (e.g., adjustment of resolution, brightness, or size) with respect to at least part of the image data. According to an embodiment of the disclosure, the pre-processing or post-processing may be performed, for example, based at least in part on one or more characteristics of the image data or one or more characteristics of the display 161. The mapping module 165d may generate a voltage value or a current value corresponding to the image data pre-processed or post-processed by the image processing module 165c. According to an embodiment of the disclosure, the generating of the voltage value or current value may be performed, for example, based at least in part on one or more attributes of the pixels (e.g., an array, such as a red green blue (RGB) stripe or a pentile structure, of the pixels, or the size of each subpixel). At least some pixels of the display 161 may be driven, for example, based at least in part on the voltage value or the current value such that visual information (e.g., a text, an image, or an icon) corresponding to the image data may be displayed via the display 161.

According to an embodiment of the disclosure, the display module 160 may further include the touch circuitry 168. The touch circuitry 168 may include a touch sensor 168a and a touch sensor IC 168b to control the touch sensor 168a. The touch sensor IC 168b may control the touch sensor 168a to detect a touch input or a hovering input with respect to a certain position on the display 161. To achieve this, for example, the touch sensor 168a may detect (e.g., measure) a change in a signal (e.g., a voltage, a quantity of light, a resistance, or a quantity of one or more electric charges) corresponding to the certain position on the display 161. The touch circuitry 168 may provide input information (e.g., a position, an area, a pressure, or a time) indicative of the touch input or the hovering input detected via the touch sensor 168a to the processor 120. According to an embodiment of the disclosure, at least part (e.g., the touch sensor IC 168b) of the touch circuitry 168 may be formed as part of the display 161 or the DDI 165, or as part of another component (e.g., the auxiliary processor 123) disposed outside the display module 160.

According to an embodiment of the disclosure, the display module 160 may further include at least one sensor (e.g., a fingerprint sensor, an iris sensor, a pressure sensor, or an illuminance sensor) of the sensor module 176 or a control circuit for the at least one sensor. In such a case, the at least one sensor or the control circuit for the at least one sensor may be embedded in one portion of a component (e.g., the display 161, the DDI 165, or the touch circuitry 168)) of the display module 160. For example, when the sensor module 176 embedded in the display module 160 includes a biometric sensor (e.g., a fingerprint sensor), the biometric sensor may obtain biometric information (e.g., a fingerprint image) corresponding to a touch input received via a portion of the display 161. As another example, when the sensor module 176 embedded in the display module 160 includes a pressure sensor, the pressure sensor may obtain pressure information corresponding to a touch input received via a partial or whole area of the display 161. According to an embodiment of the disclosure, the touch sensor 168a or the sensor module 176 may be disposed between pixels in a pixel layer of the display 161, or over or under the pixel layer.

The electronic device according to various embodiments set forth herein may be one of various types of electronic devices. The electronic device may include, for example, a portable communication device (e.g., a smart phone), a computer device, a portable multimedia device, a portable medical device, a camera, a wearable device, or a home appliance. The electronic device according to embodiments of the disclosure is not limited to those described above.

It should be appreciated that the embodiments and the terms used therein are not intended to limit the technological features set forth herein to particular embodiments and the disclosure includes various changes, equivalents, and/or alternatives for a corresponding embodiment. As used herein, each of such phrases as “A or B,” “at least one of A and B,” “at least one of A or B,” “A, B, or C,” “at least one of A, B, and C,” and “at least one of A, B, or C,” may include any one or all possible combinations of the items enumerated together in a corresponding one of the phrases. Such terms as “a first,” “a second,” “the first,” and “the second” may be used to simply distinguish a corresponding element from another, and does not limit the elements in other aspect (e.g., importance or order). If an element (e.g., a first element) is referred to, with or without the term “operatively” or “communicatively”, as “coupled with/to” or “connected with/to” another element (e.g., a second element), it means that the element may be coupled/connected with/to the other element directly (e.g., wiredly), wirelessly, or via a third element.

As used in various embodiments of the disclosure, the term “module” may include a unit implemented in hardware, software, or firmware, and may be interchangeably used with other terms, for example, “logic,” “logic block,” “component,” or “circuit”. The “module” may be a single integrated component, or a minimum unit or part thereof, adapted to perform one or more functions. For example, according to an embodiment of the disclosure, the “module” may be implemented in the form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment of the disclosure, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments of the disclosure, each component (e.g., a module or a program) of the above-described components may include a single entity or multiple entities, and some of the multiple entities may be separately disposed in different components. According to various embodiments of the disclosure, one or more of the above-described components may be omitted, or one or more other components may be added. Alternatively or additionally, a plurality of components (e.g., modules or programs) may be integrated into a single component. In such a case, according to various embodiments of the disclosure, the integrated component may still perform one or more functions of each of the plurality of components in the same or similar manner as they are performed by a corresponding one of the plurality of components before the integration. According to various embodiments of the disclosure, operations performed by the module, the program, or another component may be carried out sequentially, in parallel, repeatedly, or heuristically, or one or more of the operations may be executed in a different order or omitted, or one or more other operations may be added.

A wearable electronic device 200 according to an embodiment of the disclosure below may include the embodiments of the electronic device 101 disclosed in FIGS. 1A and 1B. For example, the wearable electronic device 200 disclosed below may include the processor 120, the memory 130, the input module 150, the sound output module 155, the display module 160, the audio module 170, the sensor module 176, the interface 177, the terminal 178, the haptic module 179, the camera module 180, the antenna module 197, and/or the subscriber identification module 196 disclosed in FIGS. 1A and 1B.

According to various embodiments of the disclosure, the wearable electronic device 200 disclosed below may include the electronic device 101 disclosed in FIG. 1A. The wearable electronic device 200 may include a display 210. For example, the display 210 may include the display module 160 disclosed in FIGS. 1A and 1B. For example, the display 210 may include a first display area 211 and a second display area 212.

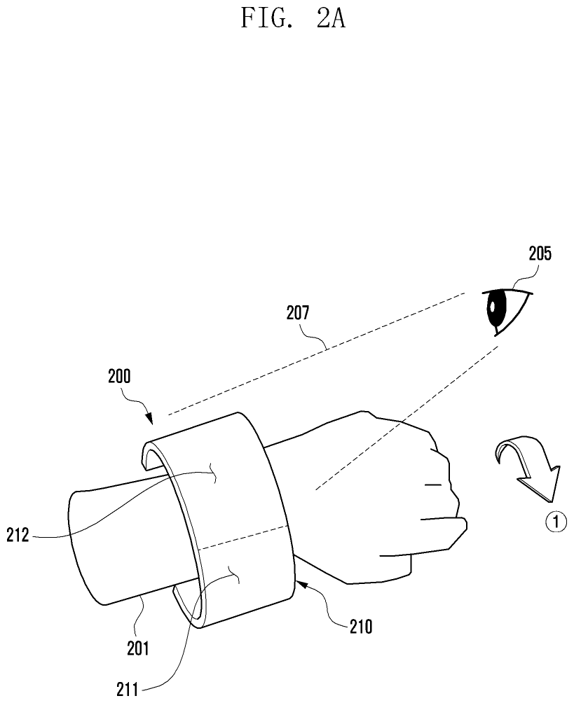

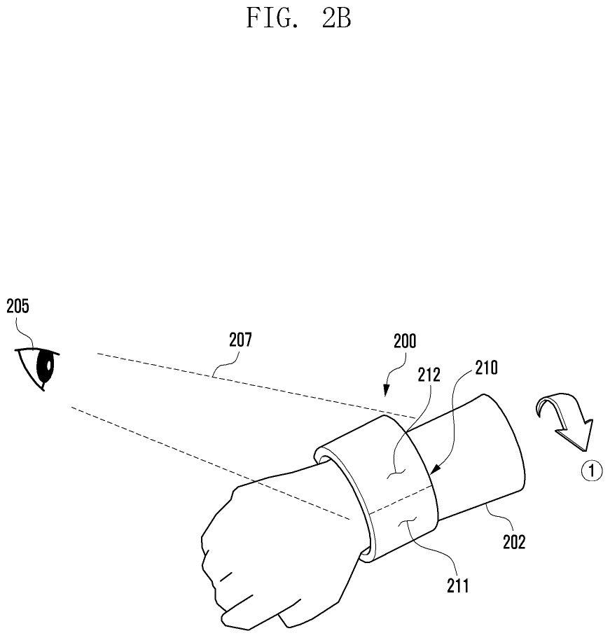

FIG. 2A is a schematic diagram of an embodiment in which a wearable electronic device is rotated in a first direction while being worn on the left wrist of a user according to an embodiment of the disclosure.

FIG. 2B is a schematic diagram of an embodiment in which a wearable electronic device is rotated in a first direction while being worn on the right wrist of a user according to an embodiment of the disclosure.

Referring to FIG. 2A, the wearable electronic device 200 may be worn on the left wrist 201 of the user.

According to an embodiment of the disclosure, while the wearable electronic device 200 is worn on the left wrist 201 of the user, the user may rotate his/her left wrist 201 in the first direction (\textcircled{1}). For example, the first direction \textcircled{1} may be a direction in which the user of the wearable electronic device 200 rotates the left wrist 201 toward the inside of the body.

According to an embodiment of the disclosure, in case that the user rotates the left wrist 201 in the first direction \textcircled{1}, the second display area 212 of the display 210 may be positioned to be more visible in the field of view 207 through the eyes 205 of the user than the first display area 211.

Referring to FIG. 2B, the wearable electronic device 200 may be worn on the right wrist 202 of the user.

According to an embodiment of the disclosure, while the wearable electronic device 200 is worn on the right wrist 202 of the user, the user may rotate the right wrist 202 in a first direction \textcircled{1}. For example, the first direction (\textcircled{1}) may be a direction in which the user of the wearable electronic device 200 rotates the right wrist 202 toward the inside of the body.

According to an embodiment of the disclosure, in case that the user rotates his/her right wrist 202 in the first direction \textcircled{1}, the second display area 212 of the display 210 may be positioned to be more visible in the field of view 207 through the eyes 205 of the user than the first display area 211.

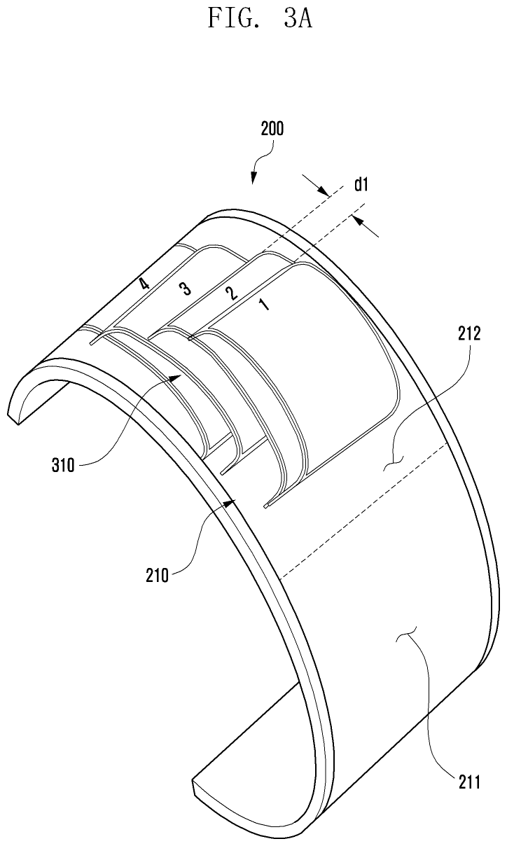

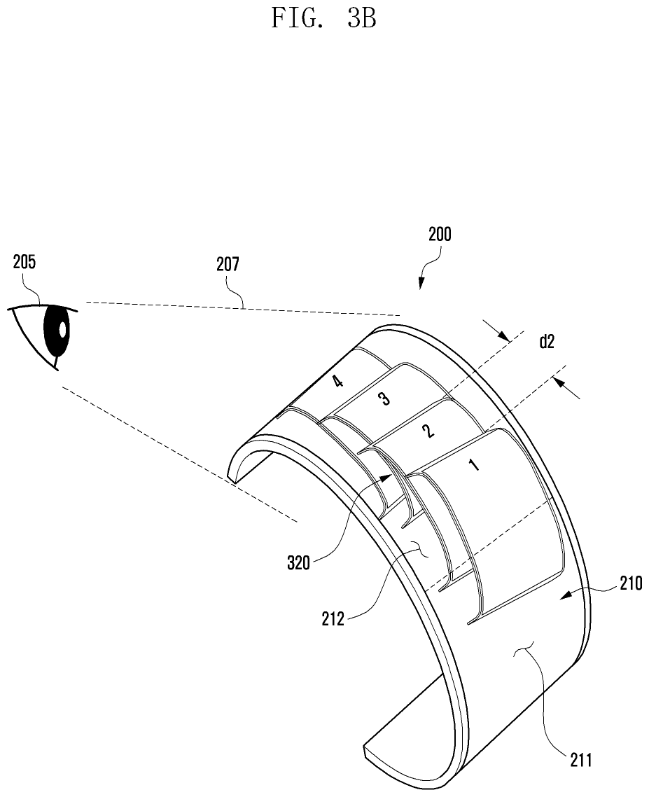

FIG. 3A is a schematic view of a first multilayer displayed in a second display area of a display of a wearable electronic device according to an embodiment of the disclosure.

FIG. 3B is a schematic view of a second multilayer displayed on a display of a wearable electronic device according to an embodiment of the disclosure.

According to an embodiment of the disclosure, the wearable electronic device 200 may receive at least one notification from an external electronic device (e.g., the external electronic devices 102 and 104 or the server 108 disclosed in FIG. 1A). For example, the wearable electronic device 200 may be paired with an external electronic device 102. The user of the wearable electronic device 200 may not identify at least one notification received from the external electronic device 102.

Referring to FIG. 3A, in case that there are multiple unidentified notifications that have not been identified by the user, the wearable electronic device 200 may display a first multilayer 310, including multiple layers each corresponding to multiple unidentified notifications, respectively, in the second display area 212 of the display 210.

According to an embodiment of the disclosure, the first multilayer 310 may include a first layer 1 corresponding to the first unidentified notification, a second layer 2 corresponding to the second unidentified notification, a third layer 3 corresponding to the third unidentified notification, and/or a fourth layer 4 corresponding to the fourth unidentified notification. For example, the first layer 1 may include a page generated to correspond to the first uncertainty notification. For example, the second layer 2 may include a page generated to correspond to the second unidentified notification. For example, the third layer 3 may include a page generated to correspond to the third uncertain notification. For example, the fourth layer 4 may include a page generated to correspond to the fourth uncertain notification.

According to an embodiment of the disclosure, the first layer 1, the second layer 2, the third layer 3, and/or the fourth layer 4 may be generated and/or displayed in order according to the degree of importance configured by the user. For example, the first layer 1, the second layer 2, the third layer 3, and/or the fourth layer 4 may be stacked in order according to the degree of importance configured by the user. According to an embodiment of the disclosure, the order in which the first layer 1, the second layer 2, the third layer 3, and/or the fourth layer 4 are stacked may be determined and/or changed according to the rank or score corresponding to the degree of importance configured by the user. For example, the first layer 1 corresponding to the first degree of importance may be positioned topmost among the first multilayer 310. For example, the second layer 2 corresponding to the second degree of importance may be positioned below the first layer 1. For example, the third layer 3 corresponding to the third degree of importance may be positioned below the second layer 2. For example, the fourth layer 4 corresponding to the fourth degree of importance may be positioned below the third layer 3.

According to an embodiment of the disclosure, the degree of importance configured by the user of the wearable electronic device 200 may include at least one of an emergency message, a notification received through a user-designated application or a main contact, a notification received through an application that is frequently used, and a notification corresponding to a schedule time.

According to an embodiment of the disclosure, the first layer 1 generated according to the first degree of importance may include a notification including an emergency message. For example, the first degree of importance may be configured to have a first score.

According to an embodiment of the disclosure, the second layer 2 generated according to the second degree of importance may include a notification received through a user-designated application or a main contact. For example, the second degree of importance may be configured to have a second score lower than the first degree of importance.

According to an embodiment of the disclosure, the third layer 3 generated based on the third degree of importance may include a notification received through an application that is frequently used by the user. For example, the third degree of importance may include a third score lower than the second degree of importance.

According to an embodiment of the disclosure, the fourth layer 4 generated according to the fourth degree of importance may include a notification corresponding to a schedule time configured by the user. For example, the fourth degree of importance may include a fourth score lower than the third degree of importance.

According to various embodiments of the disclosure, the first layer 1, the second layer 2, the third layer 3, and/or the fourth layer 4 may have an order of arrangement determined and/or changed according to ranks or scores (e.g., first to fourth scores) corresponding to degrees of importance (e.g., first to fourth degrees of importance) configured by the user.

According to various embodiments of the disclosure, the above-described degrees of importance (e.g., first to fourth degrees of importance) and/or scores (e.g., first to fourth scores) may be variously adjusted or changed according to configurations of the user of the wearable electronic device 200 and/or configurations of the manufacturer of the wearable electronic device 200.

According to an embodiment of the disclosure, the first layer 1, the second layer 2, the third layer 3, and the fourth layer 4 may be generated and/or displayed so as to at least partially overlap. For example, the first layer 1 and the second layer 2 may at least partially overlap at a first interval d1. For example, the second layer 2 and the third layer 3 may at least partially overlap at a first interval d1. For example, the third layer 3 and the fourth layer 4 may at least partially overlap at a first interval d1. For example, the first multilayer 310 may have a first size.

According to an embodiment of the disclosure, the wearable electronic device 200 may be rotated in the first direction (\textcircled{1}) (e.g., toward the inside of the user's body). In case that the wearable electronic device 200 rotates in the first direction (\textcircled{1}), the first multilayer 310 may be transformed into a second multilayer 320 having a second size, as disclosed in FIG. 3B. For example, the first size of the first multilayer 310 may include an area smaller than the second size of the second multilayer 320. For example, the second size of the second multilayer 320 may include an area larger than the first size of the first multilayer 310.

According to an embodiment of the disclosure, as the first multilayer 310 is transformed into the second multilayer 320, the first layer 1 and the second layer 2 may at least partially overlap at a second interval d2. For example, as the first multilayer 310 is transformed into the second multilayer 320, the second layer 2 and the third layer 3 may at least partially overlap at a second interval d2. For example, as the first multilayer 310 is transformed into the second multilayer 320, the third layer 3 and the fourth layer 4 may at least partially overlap at a second interval d2. For example, the second interval d2 may be wider than the first interval d1. For example, the first interval d1 may be narrower than the second interval d2.

According to an embodiment of the disclosure, as the first multilayer 310 is transformed into the second multilayer 320, the display area of at least one layer among the first layer 1, the second layer 2, the third layer 3, and the fourth layer 4 of the second multilayer 320 (e.g., the first layer 1 and the second layer 2) may be changed from the second display area 212 of the display 210 to the first display area 211 and then displayed. For example, as the first multilayer 310 is transformed into the second multilayer 320, the display area of at least one layer among the first layer 1, the second layer 2, the third layer 3, and the fourth layer 4 of the second multilayer 320 (e.g., the first layer 1 and the second layer 2) may be at least partially extended from the second display area 212 of the display 210 to the first display area 211 and displayed. For example, the display area of at least one layer among the first layer 1, the second layer 2, the third layer 3, and the fourth layer 4 (e.g., the first layer 1 and the second layer 2), which has been changed or extended from the second display area 212 of the display 210 to the first display area 211, may be displayed within the field of view 207 through the user's eyes 205. For example, the display area of at least one layer among the first layer 1, the second layer 2, the third layer 3, and the fourth layer 4 (e.g., the first layer 1 and the second layer 2), which has been changed or extended from the second display area 212 of the display 210 toward the first display area 211 may be displayed as a glance view.

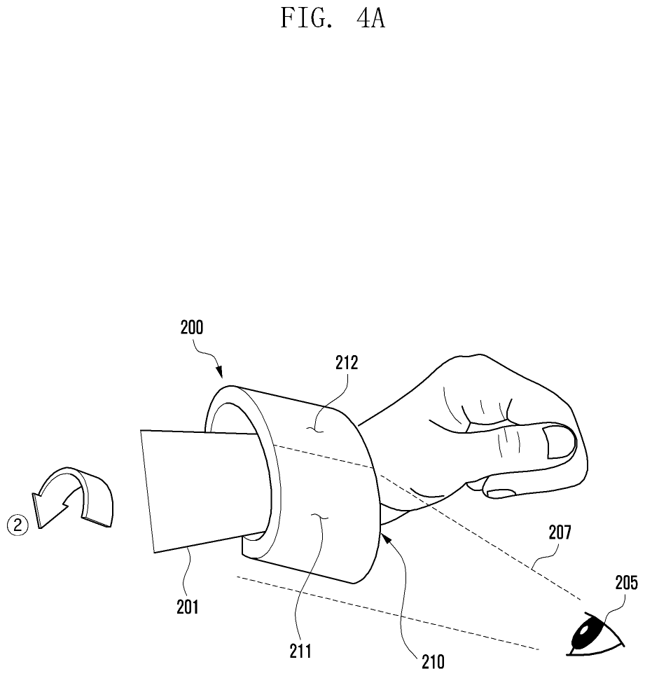

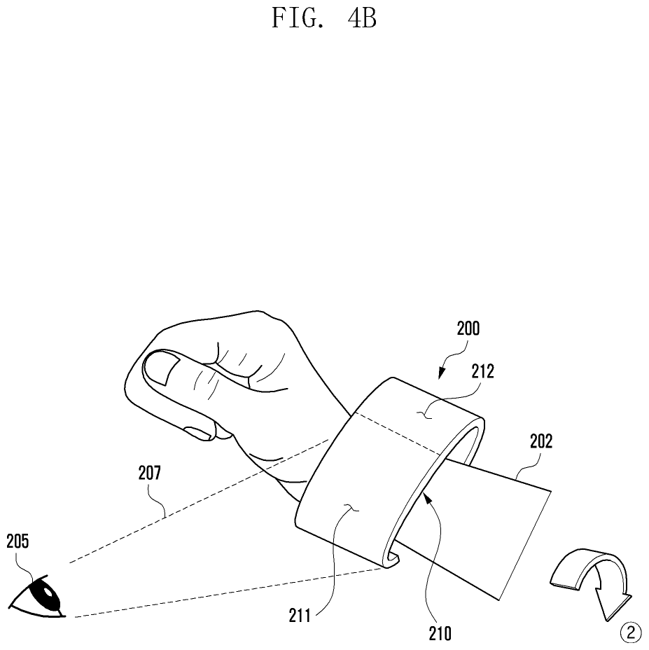

FIG. 4A is a schematic diagram of an embodiment in which a wearable electronic device is rotated in a second direction while being worn on the left wrist of a user according to an embodiment of the disclosure.

FIG. 4B is a schematic diagram of an embodiment in which a wearable electronic device is rotated in a second direction while being worn on the right wrist of a user according to an embodiment of the disclosure.

Referring to FIG. 4A, the wearable electronic device 200 may be worn on the left wrist 201 of a user.

According to an embodiment of the disclosure, while the wearable electronic device 200 is worn on the user's left wrist 201, the user may rotate his/her left wrist 201 in the second direction (\textcircled{2}). For example, the second direction \textcircled{2} may be a direction in which the user of the wearable electronic device 200 rotates the left wrist 201 outward from the body.

According to an embodiment of the disclosure, in case that the user rotates his/her left wrist 201 in the second direction (\textcircled{2}), the first display area 211 of the display 210 may be positioned to be more visible in the field of view 207 through the user's eyes 205 than the second display area 212.

Referring to FIG. 4B, the wearable electronic device 200 may be worn on the right wrist 202 of the user.

According to an embodiment of the disclosure, while the wearable electronic device 200 is worn on the user's right wrist 202, the user may rotate his/her right wrist 202 in the second direction (\textcircled{2}). For example, the second direction (\textcircled{2}) may be a direction in which the user of the wearable electronic device 200 rotates his/her right wrist 202 outward from the body.

According to an embodiment of the disclosure, in case that the user rotates his/her right wrist 202 in the second direction \textcircled{2}, the first display area 211 of the display 210 may be positioned to be more visible in the field of view 207 through the user's eyes 205 than the second display area 212.

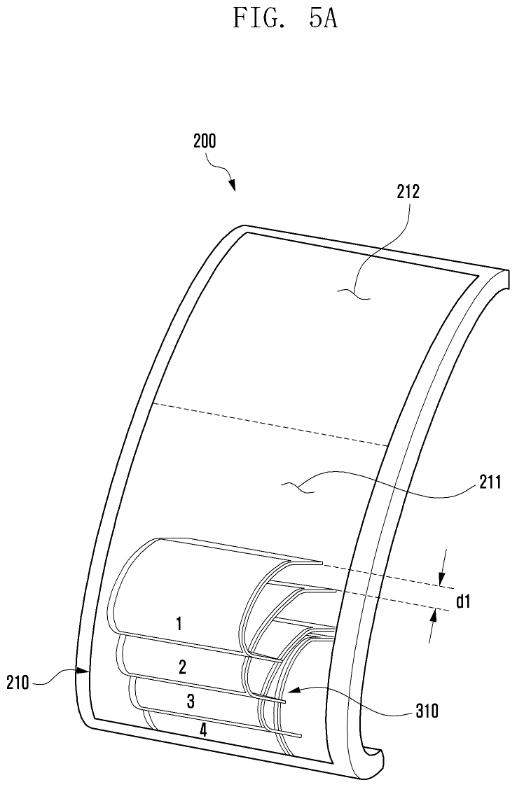

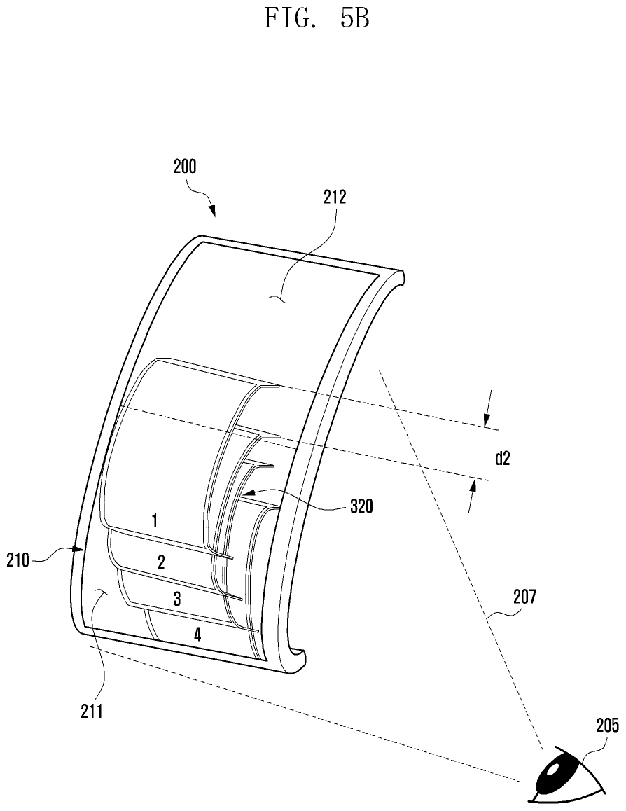

FIG. 5A is a schematic diagram of a first multilayer displayed in the first display area of the display of a wearable electronic device according to an embodiment of the disclosure.

FIG. 5B is a schematic diagram of a second multilayer displayed on the display of a wearable electronic device according to an embodiment of the disclosure.

According to an embodiment of the disclosure, the wearable electronic device 200 may receive at least one notification from an external electronic device 102. For example, the user of the wearable electronic device 200 may not identify at least one notification received from the external electronic device 102.

Referring to FIG. 5A, in case that there are multiple unidentified notifications that have not been identified by the user, the wearable electronic device 200 may display a first multilayer 310 including multiple layers corresponding to multiple unidentified notifications, respectively, in the first display area 211 of the display 210.

According to an embodiment of the disclosure, the first multilayer 310 may include a first layer 1 corresponding to the first unidentified notification, a second layer 2 corresponding to the second unidentified notification, a third layer 3 corresponding to the third unidentified notification, and/or a fourth layer 4 corresponding to the fourth unidentified notification. For example, the first layer 1 may include a page generated to correspond to the first unidentified notification. For example, the second layer 2 may include a page generated to correspond to the second uncertain notification. For example, the third layer 3 may include a page generated to correspond to the third unidentified notification. For example, the fourth layer 4 may include a page generated to correspond to the fourth unidentified notification.

According to an embodiment of the disclosure, the first layer 1, the second layer 2, the third layer 3, and the fourth layer 4 may be generated and/or displayed so as to at least partially overlap. For example, the first layer 1 and the second layer 2 may at least partially overlap at a first gap d1. For example, the second layer 2 and the third layer 3 may at least partially overlap at a first gap d1. For example, the third layer 3 and the fourth layer 4 may at least partially overlap at a first gap d1. For example, the first multilayer 310 may have a first size.

According to an embodiment of the disclosure, the wearable electronic device 200 may be rotated in the second direction (\textcircled{2}) (e.g., toward the outside of the user's body). In case that the wearable electronic device 200 is rotated in the second direction (\textcircled{2}), the first multilayer 310 may be transformed into a second multilayer 320 having a second size, as disclosed in FIG. 5B. For example, the first size of the first multilayer 310 may include an area smaller than the second size of the second multilayer 320. For example, the second size of the second multilayer 320 may include an area larger than the first size of the first multilayer 310.

According to an embodiment of the disclosure, as the first multilayer 310 is transformed into the second multilayer 320, the first layer 1 and the second layer 2 may at least partially overlap at a second interval d2. For example, as the first multilayer 310 is transformed into the second multilayer 320, the second layer 2 and the third layer 3 may may at least partially overlap at a second interval d2. For example, as the first multilayer 310 is transformed into the second multilayer 320, the third layer 3 and the fourth layer 4 may at least partially overlap at a second interval d2. For example, the second interval d2 may have a wider interval between layers than the first interval d1. For example, the first interval d1 may have a narrower interval between layers than the second interval d2.

According to an embodiment of the disclosure, as the first multilayer 310 is transformed into the second multilayer 320, the display area of at least one layer among the first layer 1, the second layer 2, the third layer 3, and the fourth layer 4 (e.g., the first layer 1 and the second layer 2) of the second multilayer 320 may be changed from the first display area 211 of the display 210 to the second display area 212 and displayed. For example, as the first multilayer 310 is transformed into the second multilayer 320, the display area of at least one layer among the first layer 1, the second layer 2, the third layer 3, and the fourth layer 4 (e.g., the first layer 1 and the second layer 2) of the second multilayer 320 may be at least partially extended from the first display area 211 of the display 210 to the second display area 212 and displayed. For example, the display area of at least one layer among the first layer 1, the second layer 2, the third layer 3, and the fourth layer 4 (e.g., the first layer 1 and the second layer 2), which has been changed or extended from the first display area 211 of the display 210 to the second display area 212, may be displayed within the field of view 207 through the user's eyes 205. For example, the display area of at least one layer among the first layer 1, the second layer 2, the third layer 3, and the fourth layer 4 (e.g., the first layer 1 and the second layer 2), which has been changed or extended from the first display area 211 of the display 210 to the second display area 212, may be displayed as a glance view.

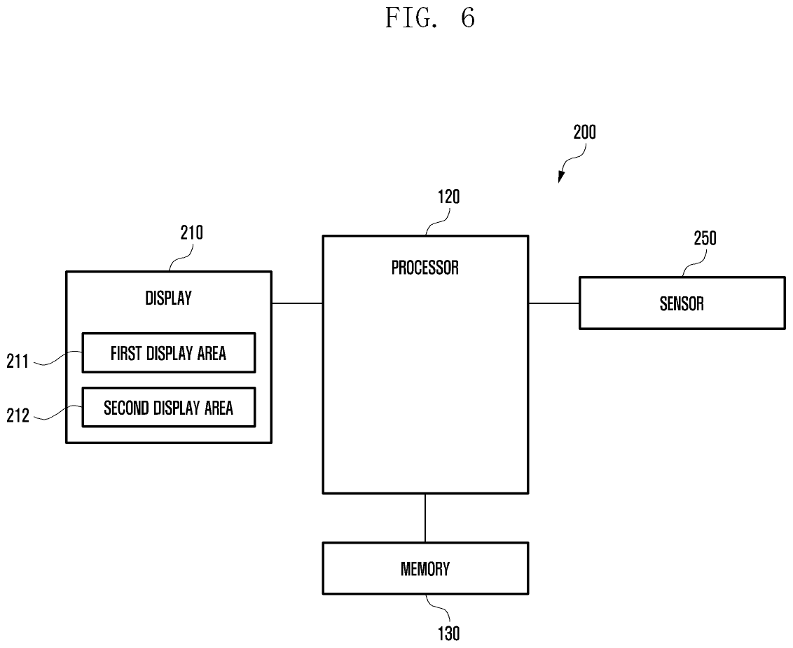

FIG. 6 is a schematic block diagram of a configuration of a wearable electronic device according to an embodiment of the disclosure.

According to various embodiments of the disclosure, the wearable electronic device 200 disclosed below may include at least some of the embodiments described with reference to FIGS. 1A, 1B, 2A, 2B, 3A, 3B, 4A, 4B, 5A, and 5B. For example, the embodiments disclosed in FIGS. 2A, 2B, 3A, 3B, 4A, 4B, 5A, and 5B may be performed through components of the wearable electronic device 200 disclosed in FIG. 6. In the following description of the wearable electronic device 200 according to an embodiment of the disclosure, components that are substantially the same as those described in the embodiments disclosed in FIGS. 1A, 1B, 2A, 2B, 3A, 3B, 4A, 4B, 5A, and 5B are denoted by the same reference numerals, and descriptions of their functions may be omitted to avoid redundancy.

Referring to FIG. 6, the wearable electronic device 200 may include a display 210, a sensor 250, memory 130, and a processor 120.

According to an embodiment of the disclosure, the display 210, the sensor 250, the memory 130, and the processor 120 may be electrically or operatively connected.

According to an embodiment of the disclosure, the display 210 may include a first display area 211 and a second display area 212. For example, in case that the user rotates his/her left wrist 201 on which the wearable electronic device 200 is worn in the second direction \textcircled{2} (e.g., toward the outside of the user's body), the first display area 211 may be positioned to be more visible in the field of view 207 through the user's eyes 205 than the second display area 212. For example, in case that the user rotates his/her left wrist 201 on which the wearable electronic device 200 is worn in the first direction \textcircled{2} (e.g., toward the inside of the user's body), the second display area 212 may be positioned to be more visible in the field of view 207 through the user's eyes 205 than the first display area 211. For example, the first display area 211 and the second display area 212 of the display 210 are divided for description, and may be substantially integrated into a single display area.

According to an embodiment of the disclosure, the display 210 may display at least one of the first multilayer 310 and the second multilayer 320 disclosed in FIGS. 3A and 3B, for example, by using the first display area 211 and/or the second display area 212. According to various embodiments of the disclosure, the display 210 may display at least one of the first multilayer 310 and the second multilayer 320 disclosed in FIGS. 5A and 5B, for example, by using the first display area 211 and/or the second display area 212.

According to various embodiments of the disclosure, the display 210 may display initial screens, background screens, configuration screens, and/or various application execution screens of the wearable electronic device 200. The display 210 may display a user interface (UI) such that various services are provided to the user of the wearable electronic device 200. The display 210 may perform display functions and input functions.

According to an embodiment of the disclosure, the sensor 250 may detect the angle of rotation of the wearable electronic device 200, which is worn on the user's left wrist 201 or right wrist 202, in the first direction \textcircled{1} (e.g., toward the inside of the user's body) or in the second direction \textcircled{2} (e.g., toward the outside of the user's body). According to various embodiments of the disclosure, the sensor 250 may detect the velocity and/or time of rotation of the wearable electronic device 200, which is worn on the user's left wrist 201 or right wrist 202, in the first direction \textcircled{1} (e.g., toward the inside of the user's body) or in the second direction \textcircled{2} (e.g., toward the outside of the user's body). For example, the sensor 250 may include the sensor module 176 disclosed in FIG. 1A.

According to various embodiments of the disclosure, the sensor 250 may include a 6-axis sensor. The sensor 250 may include an accelerometer and a gyro sensor. For example, the accelerometer may detect the angle (e.g., inclination angle) at which the wearable electronic device 20 is tilted with respect to the gravitational direction (e.g., the ground). For example, the gyro sensor may detect the angular velocity of the wearable electronic device 200 rotating in the first direction \textcircled{1} or the second direction \textcircled{2}. For example, a gyro sensor may detect the rotational velocity and/or rotational angle of the wearable electronic device 200. For example, the sensor 250 may be include an acceleration sensor and a gyro sensor combined.

According to various embodiments of the disclosure, the sensor 250 may include at least one of a rotation time detection sensor, an angle sensor, a Hall sensor, a proximity sensor, a barometric pressure sensor, a magnetic sensor, a biometric sensor, a temperature sensor, a humidity sensor, a gesture sensor, a grip sensor, a color sensor, an infrared (IR) sensor, an illuminance sensor, an ultrasonic sensor, an iris recognition sensor, a distance detection sensor (e.g., a time-of-flight (TOF) sensor or a light detection and ranging (LiDAR) sensor, and a fingerprint recognition sensor.

According to an embodiment of the disclosure, the memory 130 may store multiple layers displayed by using the first display area 211 and/or the second display area 212 of the display 210. For example, the memory 130 may store at least one of the first multilayer 310 and the second multilayer 320, which are displayed by using the first display area 211 and/or the second display area 212 of the display 210. The memory 130 may store initial screens, configuration screens, widgets, and/or various application of the wearable electronic device 200 provided through the first display area 211 and/or the second display area 212 of the display 210 of the wearable electronic device 200.

According to various embodiments of the disclosure, the memory 130 may store a user interface (UI) for providing various services to the user of the wearable electronic device 200. The memory 130 may perform the function of storing a program (e.g., the program 140 in FIG. 1A) for processing and controlling the processor 120, an operating system (e.g., the operating system 142 in FIG. 1A), various applications, and input/output data. The memory 130 may store a program for controlling the overall operation of the wearable electronic device 200. The memory 130 may store various pieces of configuration information required for functional processing in the wearable electronic device 200. The memory 130 may store at least one executable instruction. For example, the memory 130 may include one or more recording media for storing instructions. For example, the memory 130 may store at least one instruction that, when executed by the processor 120 individually or collectively, causes the wearable electronic device 200 to perform at least one operation. For example, the at least one instruction may also be stored in a computer-readable recording medium. The recording medium may be tangible and non-transitory. For example, the non-transitory computer-readable recording medium according to an embodiment may, when executed by at least one processor 120 of the wearable electronic device 200 individually or collectively, cause the at least one processor 120 to perform at least one operation. The memory 130 and/or the recording medium may store one or more programs including at least one instruction.

According to an embodiment of the disclosure, the processor 120 may be operatively connected to the display 210, the sensor 250, and the memory 130. The processor 120 may control the functions and operations of the display 210, the sensor 250, and the memory 130. The processor 120 may be configured to access the memory 130 and execute at least one instruction. The wearable electronic device 200 may include at least one processor 120.

According to various embodiments of the disclosure, the processor 120 may perform functions of controlling the overall operation of the wearable electronic device 200 and the signal flow between internal components, and processing data. The processor 120 may include, for example, a central processing unit (CPU), an application processor, and/or a communication processor. The processor 120 may include a single-core processor or a multi-core processor. The processor 120 may be configured by at least one processor. For example, the processor 120 may include an application processor (e.g., the main processor 121 in FIG. 1A) and a sensor hub processor (e.g., the auxiliary processor 123 in FIG. 1A). For example, the processor 120 may include processing circuitry.

According to various embodiments of the disclosure, operations performed in the wearable electronic device 200 may be performed and/or executed by at least one instruction stored in the processor 120 and/or the memory 130. For example, the instructions stored in the memory 130 and/or the one or more recording media storing the instructions may be executed by the at least one processor 120 individually or collectively. For example, in the disclosure, an embodiment in which the wearable electronic device 200 may perform a specific operation may be interpreted as meaning that the operation is performed by the processor 120, at least one instruction stored in the memory 130, and/or a recording medium.

According to an embodiment of the disclosure, the wearable electronic device 200 may display a first multilayer 310 having a first size in which at least a part of a first layer 1 corresponding to a first unidentified notification and a second layer 2 corresponding to a second unidentified notification overlap, as disclosed in FIG. 3A, for example, in the second display area 212. For example, the first layer 1 may be generated to correspond to the first unidentified notification. For example, the second layer 2 may be generated to correspond to the second unidentified notification. For example, based on the degree of importance configured by the user, the first layer 1 may be positioned above the second layer 2. For example, the first layer 1 may be generated based on a first degree of importance and a first score. For example, the second layer 2 may be generated based on a second degree of importance and a second score lower than the first score.

According to an embodiment of the disclosure, the first multilayer 310 has been described as including the first layer 1 and the second layer 2, but is not limited thereto and may further include multiple layers (e.g., the third layer 3 and the fourth layer 4 disclosed in FIG. 3A) generated to correspond to the number of unidentified notifications.

According to an embodiment of the disclosure, the first unidentified notification may include a first degree of importance configured by the user. For example, the second unidentified notification may include a second degree of importance configured by the user. For example, the first degree of importance may include a higher degree of importance than the second degree of importance. For example, the degree of importance configured by the user of the wearable electronic device 200 may include at least one of an emergency message notification, a notification received through a user-designated application or a main contact, a notification received through a frequently used application, and a notification corresponding to a schedule time.

According to an embodiment of the disclosure, the first layer 1 generated according to the first degree of importance may include a notification including an emergency message. For example, the first degree of importance may be configured to have a first score. For example, the emergency message may include notifications corresponding to disaster situations, such as heavy rain warnings, typhoon information, earthquake information, or power outage information.

According to an embodiment of the disclosure, the second layer 2 generated according to the second degree of importance may include a notification received through a user-designated application or a main contact. For example, the second degree of importance may be configured to have a second score lower than the first degree of importance.

According to an embodiment of the disclosure, the third layer 3 generated according to the third degree of importance may include a notification received through an application that is frequently used by the user. For example, the third degree of importance may include a third score lower than the second degree of importance.

According to an embodiment of the disclosure, the fourth layer 4 generated based on the fourth degree of importance may include a notification corresponding to a schedule time configured by the user. For example, the fourth degree of importance may include a fourth score lower than the third degree of importance.

According to various embodiments of the disclosure, the first layer 1, the second layer 2, the third layer 3, and/or the fourth layer 4 may have an order of arrangement determined and/or changed according to ranks or scores (e.g., first to fourth scores) corresponding to degrees of importance (e.g., first to fourth degrees of importance) configured by the user.

According to various embodiments of the disclosure, the above-described degrees of importance (e.g., first to fourth degrees of importance) and/or scores (e.g., first to fourth scores) may be variously adjusted or changed according to configurations of the user of the wearable electronic device 200 and/or configurations of the manufacturer of the wearable electronic device 200.

According to an embodiment of the disclosure, the wearable electronic device 200 may detect whether the same rotates in the first direction (\textcircled{1}) or in the second direction (\textcircled{2}) by using the sensor 250. For example, in case that the wearable electronic device 200 rotates in the first direction \textcircled{1} (e.g., toward the inside of the user's body), the wearable electronic device 200 may transform a first multilayer 310 having a first size into a second multilayer 320 having a second size, as disclosed in FIGS. 3A and 3B.

According to an embodiment of the disclosure, the wearable electronic device 200 may change the display area of at least one of the first layer 1 and the second layer 2, which have been transformed into the second multilayer 320, from the second display area 212 to the first display area 211 and display the same. For example, the wearable electronic device 200 may extend the display area of at least one of the first layer 1 and the second layer 2, which have been transformed into the second multilayer 320, from the second display area 212 to the first display area 211 and display the same. For example, the wearable electronic device 200 may display the display area of at least one of the first layer 1 and the second layer 2, which have been transformed into the second multilayer 320, as a glance view that is changed or extended from the second display area 212 to the first display area 211, based on the wearable electronic device 200 rotating in the first direction \textcircled{1} (e.g., toward the inside of the user's body).

According to various embodiments of the disclosure, the wearable electronic device 200 may display a first multilayer 310 having a first size in which a first layer 1 corresponding to a first unidentified notification and a second layer 2 corresponding to a second unidentified notification at least partially overlap, as disclosed in FIG. 5A, for example, in the first display area 211. For example, the first layer 1 may be generated to correspond to the first unidentified notification. For example, the second layer 2 may be generated to correspond to the second unidentified notification. For example, based on the degree of importance configured by the user of the wearable electronic device 200, the first layer 1 having a high degree of importance may be positioned above the second layer 2 having a low degree of importance. For example, the first layer 1 may be generated and/or displayed, based on a first degree of importance and a first score, according to the user's configuration. For example, the second layer 2 may be generated and/or displayed based on a second degree of importance and a second score, according to the user's configuration.

In an embodiment of the disclosure, the first multilayer 310 has been described as including a first layer 1 and a second layer 2, but is not limited thereto, and may further include multiple layers (e.g., the third layer 3 and the fourth layer 4 disclosed in FIG. 5A) generated to correspond to the number of unidentified notifications.

According to an embodiment of the disclosure, the wearable electronic device 200 may detect whether the same rotates in the first direction \textcircled{1} or in the second direction \textcircled{2} by using the sensor 250. For example, in case that the wearable electronic device 200 rotates in the second direction (\textcircled{2}) (e.g., toward the outside of the user's body), the wearable electronic device 200 may transform a first multilayer 310 having a first size into a second multilayer 320 having a second size, as disclosed in FIGS. 5A and 5B.

According to an embodiment of the disclosure, the wearable electronic device 200 may change the display area of at least one of the first layer 1 and the second layer 2, which have been transformed into the second multilayer 320, from the first display area 211 to the second display area 212 and display the same. For example, the wearable electronic device 200 may extend the display area of at least one of the first layer 1 and the second layer 2, which have been transformed into the second multilayer 320, from the first display area 211 to the second display area 212 and display the same. For example, the wearable electronic device 200 may display the display area of at least one of the first layer 1 and the second layer 2, which have been transformed into the second multilayer 320, as a glance view that is changed or extended from the first display area 211 to the second display area 212, based on the wearable electronic device 200 rotating in the second direction (\textcircled{2}) (e.g., toward the outside of the user's body).

According to an embodiment of the disclosure, the wearable electronic device 200 may configure a first application having a first degree of importance and a second application having a second degree of importance, which are displayed through a swipe operation (e.g., a swipe gesture) on the display 210. According to an embodiment of the disclosure, the wearable electronic device 200 may generate and/or display a first layer 1 corresponding to the first degree of importance and a second layer 2 corresponding to the second degree of importance, based on the configured first degree of importance and second degree of importance. For example, a first unidentified notification may be received through the first application 1010, and a second unidentified notification may be received through the second application 1020.

According to an embodiment of the disclosure, the wearable electronic device 200 may determine the order of the first unidentified notification and the second unidentified notification, based on the degree of importance configured by the user, with regard to at least one application and/or at least one widget. For example, the wearable electronic device 200 may determine the order of the first layer 1 generated to correspond to a first unidentified notification and the second layer 2 generated to correspond to a second unidentified notification, based on the degree of importance configured by the user. For example, in case that the first unidentified notification has a higher degree of importance than the second unidentified notification, the wearable electronic device 200 may position the first layer 1 of the first multilayer 310 above the second layer 2. For example, in case that the second unidentified notification has a lower degree of importance than the first unidentified notification, the wearable electronic device 200 may position the second layer 2 of the first multilayer 310 below the first layer 1.

According to an embodiment of the disclosure, in case that the first layer 1 has a first degree of importance and the second layer has a second degree of importance, the first layer 1 may be generated and/or displayed to be positioned above the second layer 2.

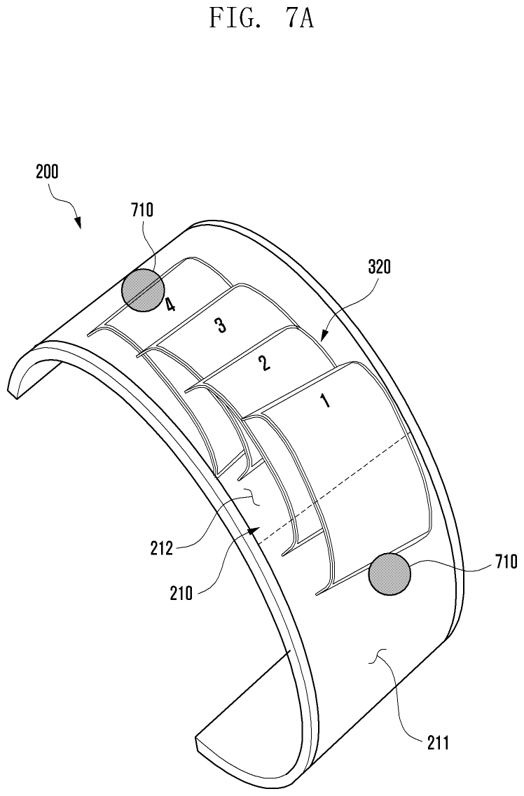

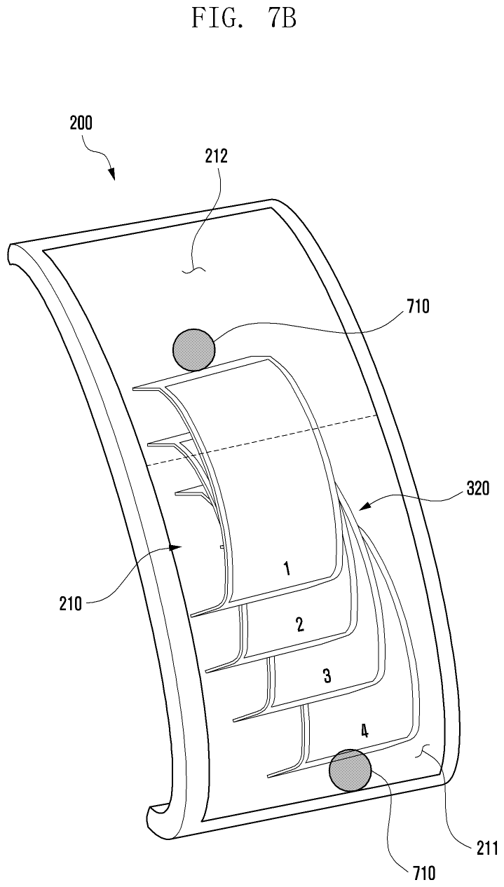

FIG. 7A is a schematic diagram of an embodiment in which a specific icon is displayed on a display when a wearable electronic device rotates in a first direction according to an embodiment of the disclosure.

FIG. 7B is a schematic diagram of an embodiment in which a specific icon is displayed on a display when a wearable electronic device rotates in a second direction according to an embodiment of the disclosure.

According to an embodiment of the disclosure, the wearable electronic device 200 may display a first multilayer 310 having a first size in the second display area 212 as disclosed in FIG. 3A, for example.

Referring to FIG. 7A, an indicator indicating the state of the wearable electronic device 200 or an icon 710 indicating an application currently used in the wearable electronic device 200 may be displayed in the second display area 212.

According to an embodiment of the disclosure, in case that the wearable electronic device 200 rotates in the first direction (\textcircled{1}) (e.g., toward the inside of the user's body), the wearable electronic device 200 may transform the first multilayer 310 having a first size into a second multilayer 320 having a second size, as disclosed in FIG. 7A.

According to an embodiment of the disclosure, based on the wearable electronic device 200 rotating in the first direction (\textcircled{1}) (e.g., toward the inside of the user′ s body), the icon 710 displayed in the second display area 212 may also be additionally displayed in the first display area 211.

According to various embodiments of the disclosure, an indicator indicating the state of the wearable electronic device 200 or an icon 710 indicating an application currently used in the wearable electronic device 200 may be displayed in only one of the first display area 211 and the second display area 212.

According to an embodiment of the disclosure, the icon 710 indicating an indicator representing the state of the wearable electronic device 200 may, for example, include an indicator indicating the connection or disconnection between the wearable electronic device 200 and the external electronic device 102 (e.g., a smartphone). According to an embodiment of the disclosure, the icon 710 indicating an application currently used in the wearable electronic device 200 may include an icon related to a health application which may be used to identify in real time whether the user is exercising.

According to various embodiments of the disclosure, the wearable electronic device 200 may display a first multilayer 310 having a first size in the first display area 211, as disclosed in FIG. 5A, for example.

Referring to FIG. 7B, an indicator indicating the state of the wearable electronic device 200 or an icon 710 indicating an application currently used in the wearable electronic device 200 may be displayed in the first display area 211.

According to an embodiment of the disclosure, in case that the wearable electronic device 200 rotates in the second direction (\textcircled{2}) (e.g., toward the outside of the user's body), the wearable electronic device 200 may transform the first multilayer 310 having a first size into a second multilayer 320 having a second size, as disclosed in FIG. 7B.

According to an embodiment of the disclosure, based on the wearable electronic device 200 rotating in the second direction \textcircled{2} (e.g., toward the outside of the user's body), the icon 710 displayed in the first display area 211 may be additionally displayed in the second display area 212.

According to various embodiments of the disclosure, an indicator indicating the state of the wearable electronic device 200 or an icon 710 indicating an application currently used in the wearable electronic device 200 may be displayed in only one of the first display area 211 and the second display area 212.

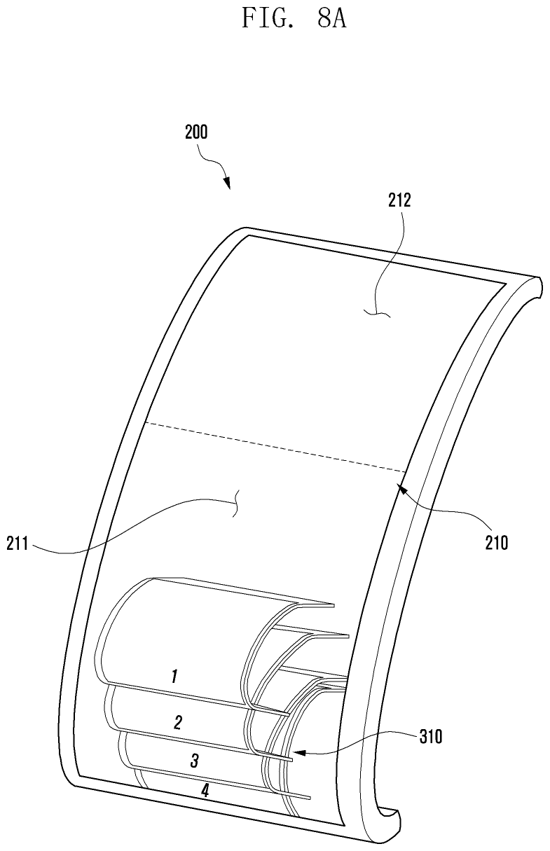

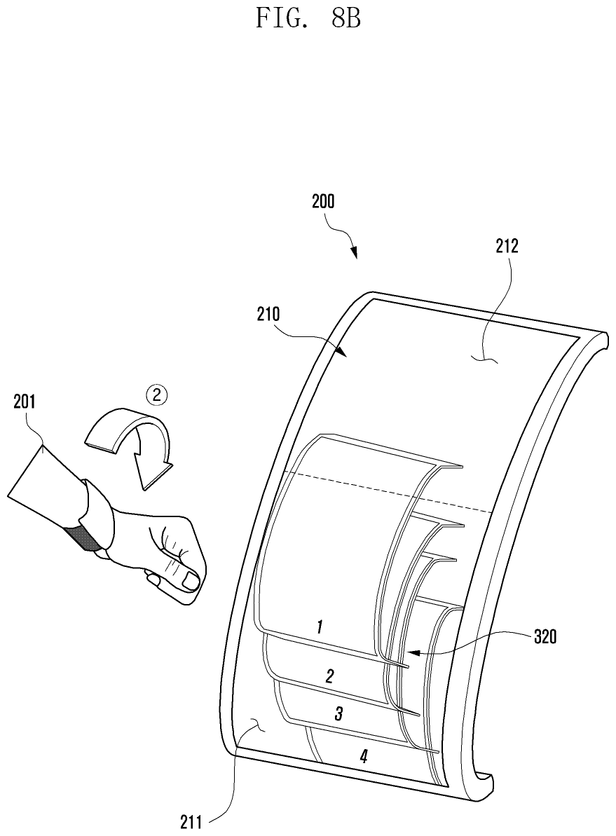

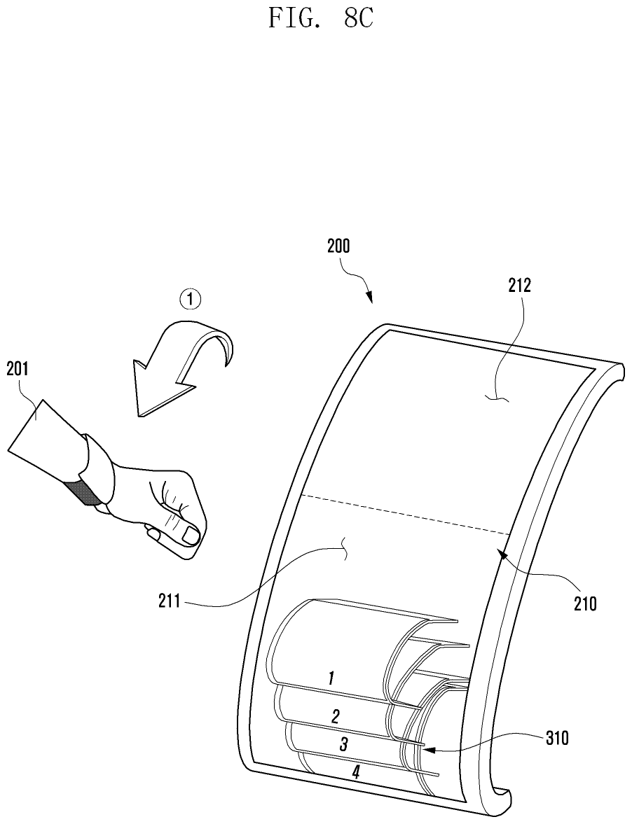

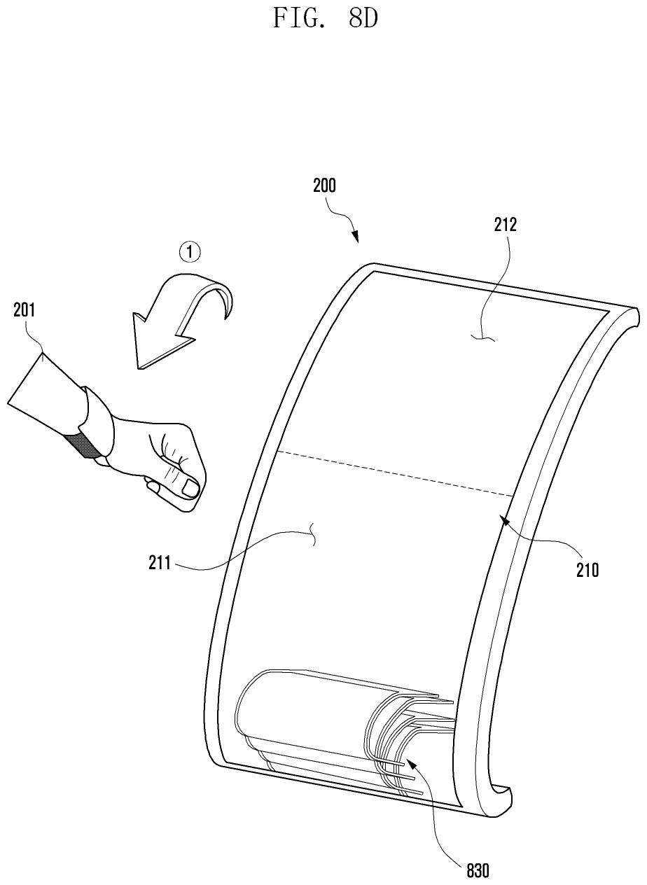

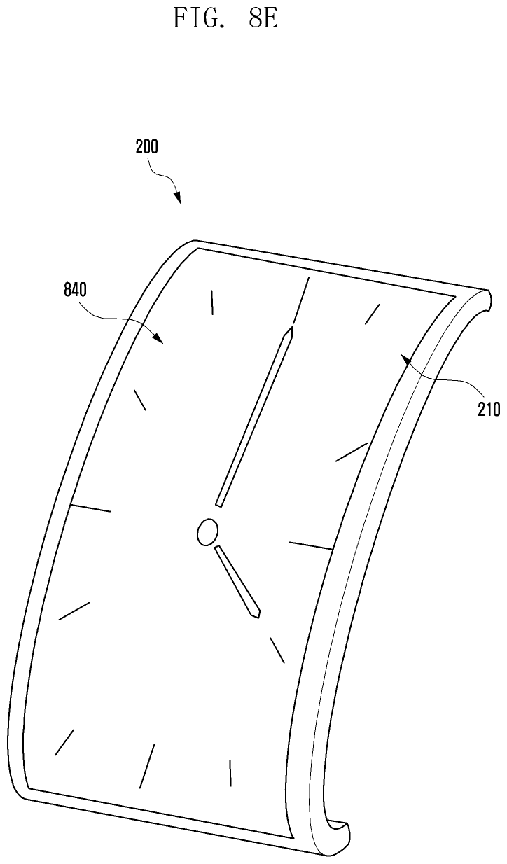

FIGS. 8A to 8E are schematic diagrams of operations in which a multilayer is transformed and switched to an initial screen, based on a rotation of a wearable electronic device in a first direction or a second direction according to various embodiments of the disclosure.

According to various embodiments of the disclosure, FIG. 8A is a schematic diagram of a first multilayer 310 of a wearable electronic device 200 according to an embodiment of the disclosure.

FIG. 8B is a schematic diagram of a second multilayer 320 which is transformed based on the wearable electronic device 200 rotating in a second direction (\textcircled{2}) according to an embodiment of the disclosure.

FIG. 8C is a schematic diagram of a first multilayer 310 which is transformed based on the wearable electronic device 200 rotating at a first angle in a first direction \textcircled{1} according to an embodiment of the disclosure.

FIG. 8D is a schematic diagram of a third multilayer 830 which is transformed based on the wearable electronic device 200 rotating at a second angle in a first direction \textcircled{1} according to an embodiment of the disclosure.

FIG. 8E is a schematic diagram of a background screen 840 of a wearable electronic device 200, which has been switched based on the wearable electronic device 200 rotating at a third angle in a first direction \textcircled{1} according to an embodiment of the disclosure.

Referring to FIG. 8A, in case that there are multiple unidentified notifications that have not been identified by the user, the wearable electronic device 200 may display a first multilayer 310 including multiple layers corresponding to the multiple unidentified notifications, respectively, in the first display area 211 of the display 210.

According to an embodiment of the disclosure, the first multilayer 310 may include a first layer 1 corresponding to the first unidentified notification, a second layer 2 corresponding to the second unidentified notification, a third layer 3 corresponding to the third unidentified notification, and/or a fourth layer 4 corresponding to the fourth unidentified notification. For example, each of the first layer 1, the second layer 2, the third layer 3, and the fourth layer 4 may at least partially overlap. For example, the first multilayer 310 may have a first size.

Referring to FIG. 8B, the wearable electronic device 200 may rotate in the second direction \textcircled{2} (e.g., toward the outside of the user's body) while being worn on the user's left wrist 201. In case that the wearable electronic device 200 rotates in the second direction \textcircled{2}, the first multilayer 310 may be transformed into a second multilayer 320 having a second size. For example, the second size of the second multilayer 320 may include a larger or wider area than the first size of the first multilayer 310.

According to an embodiment of the disclosure, as the first multilayer 310 is transformed into the second multilayer 320, at least one of the first layer 1, the second layer 2, the third layer 3, and the fourth layer 4 of the second multilayer 320 (e.g., the first layer 1) may be changed from the first display area 211 of the display 210 to the second display area 212 and displayed. For example, as the first multilayer 310 is transformed into the second multilayer 320, at least one layer of the first layer 1, the second layer 2, the third layer 3, and the fourth layer 4 of the second multilayer 320 (e.g., the first layer 1) may be extended from the first display area 211 of the display 210 to the second display area 212 and displayed. For example, at least one of the first layer 1, the second layer 2, the third layer 3, and the fourth layer 4, which is extended from the first display area 211 of the display 210 toward the second display area 212, may be displayed as a glance view.

Referring to FIG. 8C, in a state where the wearable electronic device 200 is rotated in the second direction (\textcircled{2}) (e.g., toward the outside of the user's body), and at least one of the first layer 1, second layer 2, third layer 3, and fourth layer 4 of the second multilayer 320 is changed or extended from the first display area 211 of the display 210 to the second display area 212 and displayed, the user may rotate the left wrist 201 on which the wearable electronic device 200 is worn by a first angle in the first direction (\textcircled{1}) within a first designated time.

According to an embodiment of the disclosure, in case that the wearable electronic device 200 is rotated by a first angle in the first direction (\textcircled{1}) within a first designated time, the second multilayer 320 disclosed in FIG. 8B, for example, may be transformed into the first multilayer 310. For example, the transformed first multilayer 310 may be displayed in the first display area 211.

Referring to FIG. 8D, in a state where the second multilayer 320 is transformed into the first multilayer 310 and displayed on the first display area 211, based on the wearable electronic device 200 rotating by a first angle in the first direction \textcircled{1} within a first specified time, the user may rotate his/her left wrist 201 on which the wearable electronic device 200 is worn by a second angle in the first direction \textcircled{1} within the first specified time. For example, the second angle of rotation in the first direction (\textcircled{1}) may be a larger angle of rotation toward the inside of the user's body or the ground than the first angle described above.

According to an embodiment of the disclosure, in case that the wearable electronic device 200 rotates by a second angle in the first direction \textcircled{1} within a first specified time, the first multilayer 310 disclosed in FIG. 8C, for example, may be transformed into a third multilayer 830 having a third size. For example, the transformed third multilayer 830 may be displayed in the first display area 211. For example, the third multilayer 830 having the third size may include an area smaller than the first multilayer 310. For example, the interval between each of the multiple layers included in the transformed third multilayers 830 may be formed to be narrower than the interval (e.g., the first interval d1 in FIG. 5A) between each of the multiple layers included in the first multilayers 310. For example, the third size of the third multilayer 830 may include a reduced size compared to the first size of the first multilayer 310.

Referring to FIG. 8E, in a state where the transformed third multilayer 830 is displayed in the first display area 211, based on the wearable electronic device 200 rotating by a second angle in the first direction \textcircled{1} within a first specified time, the user may rotate his/her left wrist 201 on which the wearable electronic device 200 is worn by a third angle in the first direction \textcircled{1} within the first specified time. For example, the third angle of rotation in the first direction (\textcircled{1}) may be a larger angle of rotation toward the ground than the second angle described above. For example, the third angle may be a threshold angle of rotation of the wearable electronic device 200 in the first direction \textcircled{1}.

According to an embodiment of the disclosure, in case that the wearable electronic device 200 rotates by a third angle in the first direction \textcircled{1} within a first specified time, the first multilayer 310 disclosed in FIG. 8C or the third multilayer 830 disclosed in FIG. 8D may be removed from the display 210. According to various embodiments of the disclosure, in case that the wearable electronic device 200 rotates by a third angle (e.g., a threshold value) in the first direction \textcircled{1} within the first designated time, the first multilayer 310 disclosed in FIG. 8C or the third multilayer 830 disclosed in FIG. 8D may be switched to the background screen 840 (e.g., a clock screen) of the wearable electronic device 200.

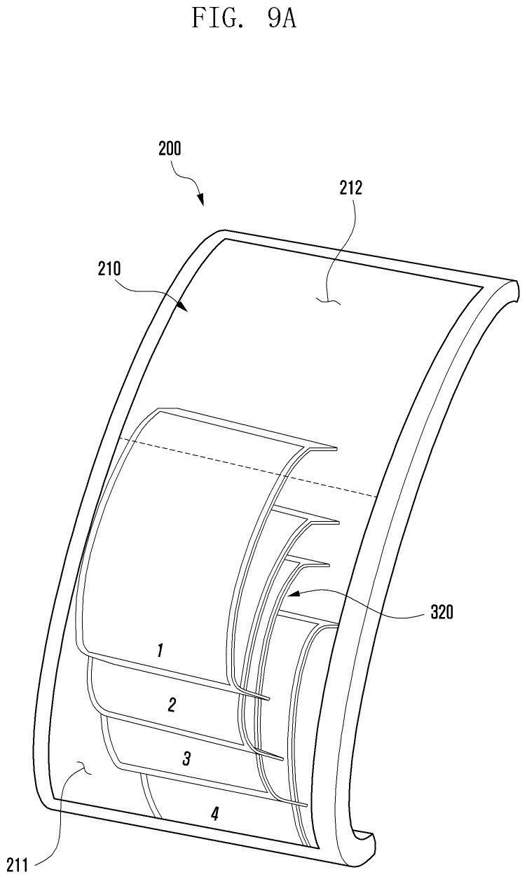

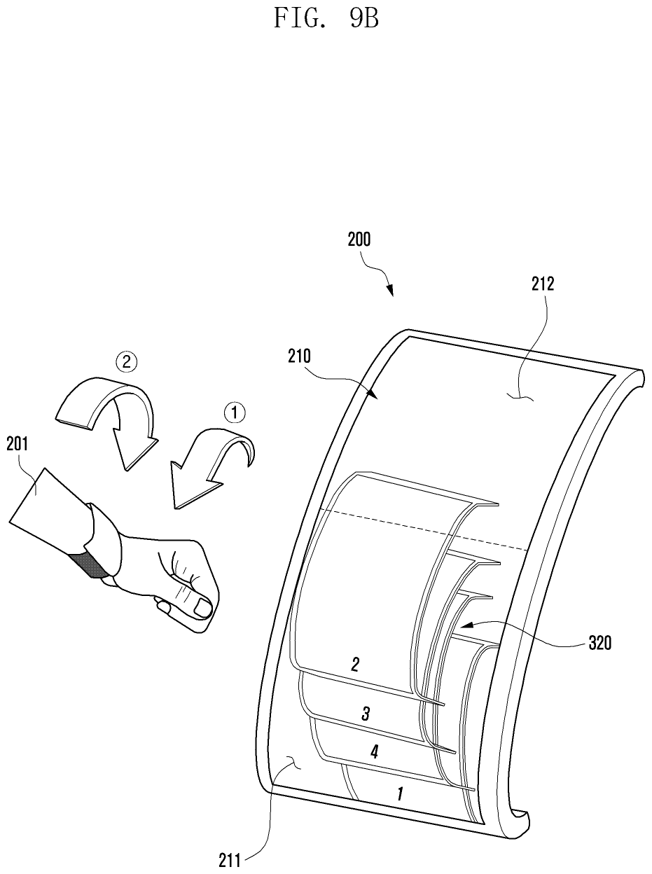

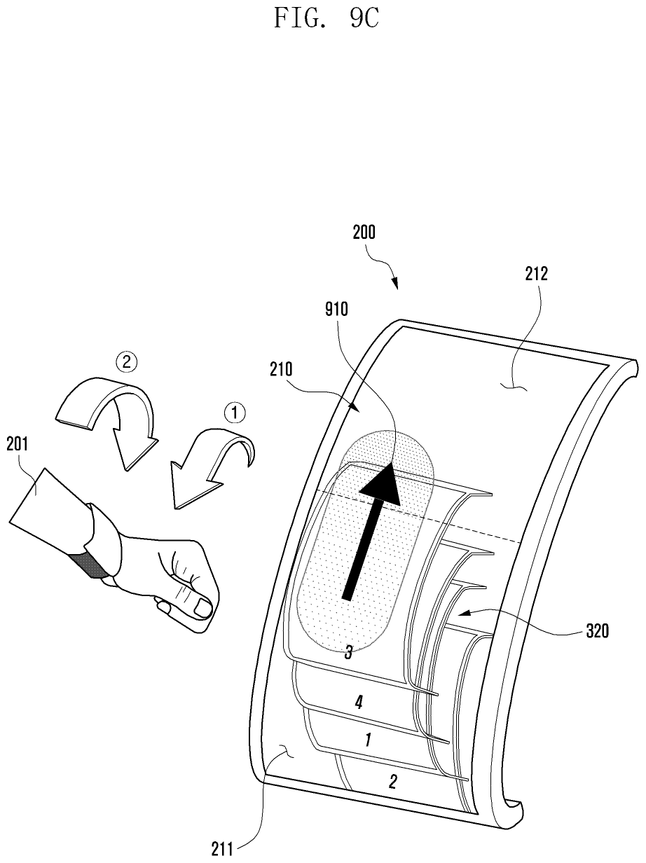

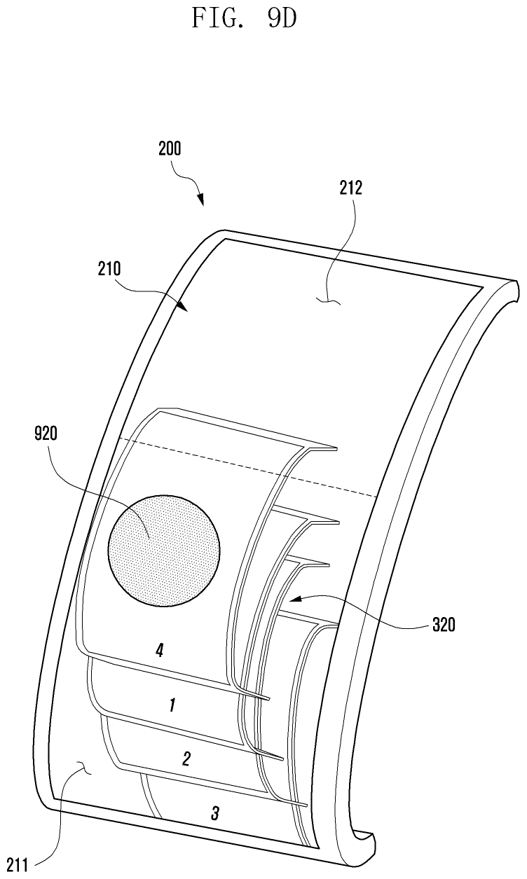

FIG. 9A is a schematic diagram of a second multilayer displayed on a display based on a wearable electronic device rotating in a second direction according to an embodiment of the disclosure.

FIG. 9B is a schematic diagram of an embodiment in which the order of layers is changed based on a wearable electronic device rotating from a second direction to a first direction within a second designated time according to an embodiment of the disclosure.

FIG. 9C is a schematic diagram of an embodiment in which layers displayed on a display of a wearable electronic device are changed through a swipe operation according to an embodiment of the disclosure.

FIG. 9D is a schematic diagram of an operation of touching layers displayed on a display of a wearable electronic device according to an embodiment of the disclosure.

According to an embodiment of the disclosure, in case that there are multiple unidentified notifications that the user has not identified, the wearable electronic device 200 may display a first multilayer 310 including multiple layers corresponding to the multiple unidentified notifications, respectively, in the first display area 211 of the display 210.

According to an embodiment of the disclosure, the first multilayer 310 may include a first layer 1 corresponding to the first unidentified notification, a second layer 2 corresponding to the second unidentified notification, a third layer 3 corresponding to the third unidentified notification, and/or a fourth layer 4 corresponding to the fourth unidentified notification. For example, each of the first layer 1, the second layer 2, the third layer 3, and the fourth layer 4 may at least partially overlap. For example, the first multilayer 310 may have a first size.

Referring to FIG. 9A, the wearable electronic device 200 may rotate in the second direction (\textcircled{2}) (e.g., toward the outside of the user's body) while being worn on the user's left wrist 201. In case that the wearable electronic device 200 is rotated in the second direction (\textcircled{2}), the first multilayer 310 may be transformed into a second multilayer 320 having a second size.

According to an embodiment of the disclosure, as the first multilayer 310 is transformed into the second multilayer 320, at least one layer among the first layer 1, second layer 2, third layer 3, and fourth layer 4 (e.g., the first layer 1) of the second multilayer 320 may be changed from the first display area 211 of the display 210 to the second display area 212 and displayed. For example, as the first multilayer 310 is transformed into the second multilayer 320, at least one layer among the first layer 1, second layer 2, third layer 3, and fourth layer 4 (e.g., the first layer 1) of the second multilayer 320 may be extended from the first display area 211 of the display 210 to the second display area 212 and displayed. For example, at least one of the first layer 1, the second layer 2, the third layer 3, and the fourth layer 4, which is changed or extended from the first display area 211 of the display 210 to the second display area 212, may be displayed as a glance view.

Referring to FIG. 9B, in a state where the wearable electronic device 200 is rotated in the second direction (\textcircled{2}) (e.g., toward the outside of the user's body), and at least one layer among the first layer 1, the second layer 2, the third layer 3, and the fourth layer 4 (e.g., the first layer 1) of the second multilayer 320 is changed or extended from the first display area 211 of the display 210 to the second display area 212 and displayed, the user may rotate his/her left wrist 201 on which the wearable electronic device 200 is worn in the first direction (\textcircled{1}) within a second designated time. For example, the wearable electronic device 200 may be rotated from the second direction \textcircled{2} in the first direction \textcircled{1} within a second specified time.

According to an embodiment of the disclosure, in case that the wearable electronic device 200 rotates from the second direction \textcircled{2} in the first direction \textcircled{1} within a second designated time, the order of layers may be switched such that the first layer 1 which is positioned topmost among the second multilayer 320 is positioned below the fourth layer 4 which is positioned bottommost. For example, in case that the wearable electronic device 200 rotates from the second direction \textcircled{2} in the first direction \textcircled{1} within a second designated time, the order of layers may be switched such that the second layer 2 which is positioned below the first layer 1 is positioned topmost among the second multilayer 320.

Referring to FIG. 9C, in case that the wearable electronic device 200 is rotated once more from the second direction (\textcircled{2}) in the first direction (\textcircled{1}) within the second designated time, the order of layers may be switched such that the second layer 2 which is positioned topmost among the second multilayer 320, for example, is positioned below the first layer 1 which is positioned bottommost. For example, in case that the wearable electronic device 200 is rotated once more from the second direction (\textcircled{2}) in the first direction (\textcircled{1}) within the second designated time, the order of layers may be switched such that the third layer 3 which is positioned below the second layer 2, is positioned topmost among the second multilayer 320. For example, based on the wearable electronic device 200 rotating from the second direction \textcircled{2} in the first direction \textcircled{1} within the second designated time, the second multilayer 320 may be arranged in the order of the third layer 3, the fourth layer 4, the first layer 1, and the second layer 2.

According to an embodiment of the disclosure, the user of the wearable electronic device 200 may perform a swipe input 910 (e.g., a swipe gesture) with respect to the third layer 3 which is positioned topmost among the second multilayer 320. For example, the user may swipe the third layer 3 which is positioned topmost among the second multilayer 320 in the upward direction using a finger.

Referring to FIG. 9D, in a state where the second multilayer 320 is arranged in the order of the third layer 3, the fourth layer 4, the first layer 1, and the second layer 2, in case that a swipe input 910 is performed with respect to the third layer 3 positioned topmost, the order of the layers may be changed such that the third layer 3 which is positioned topmost among the second multilayer 320 is positioned below the second layer 2 which is positioned bottommost. For example, in a state where the second multilayer 320 is arranged in the order of the third layer 3, the fourth layer 4, the first layer 1, and the second layer 2, in case that a swipe input 910 is performed with respect to the third layer 3 which is positioned topmost, the order of layers may be changed such that the fourth layer 4 which is positioned below the third layer 3 is positioned topmost among the second multilayer 320.

According to an embodiment of the disclosure, the user of the wearable electronic device 200 may perform a touch input 920 (e.g., a touch gesture) with respect to the fourth layer 4 which is positioned topmost among the second multilayer 320. For example, in case that a touch input 920 is performed with respect to the fourth layer 4 which is positioned topmost among the second multilayer 320, the wearable electronic device 200 may display an application or a widget corresponding to the fourth layer 4 on the display 210.

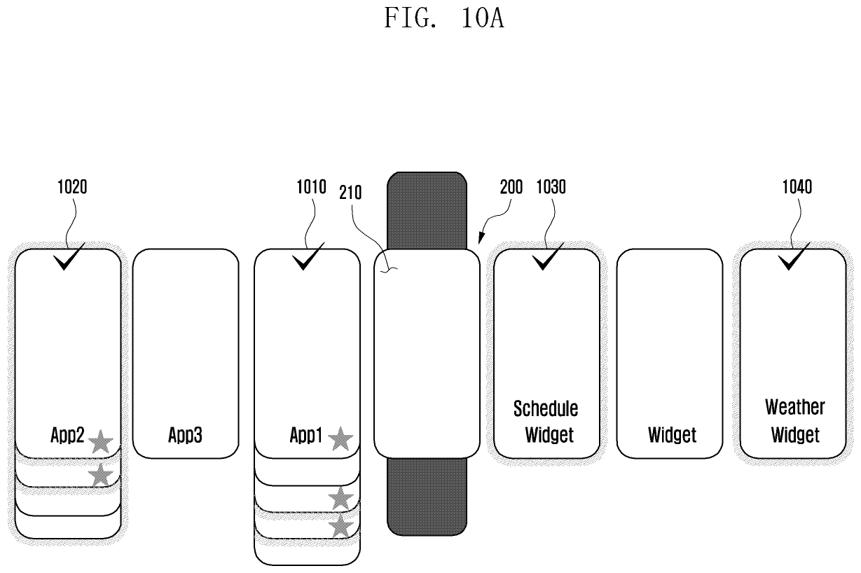

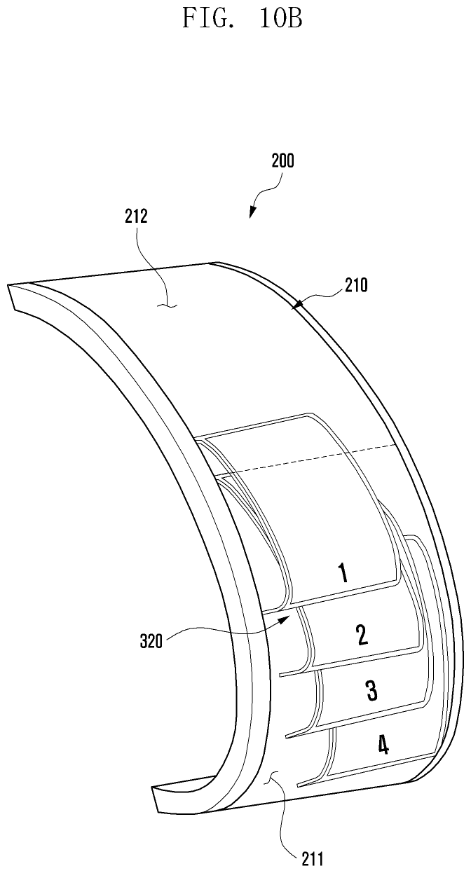

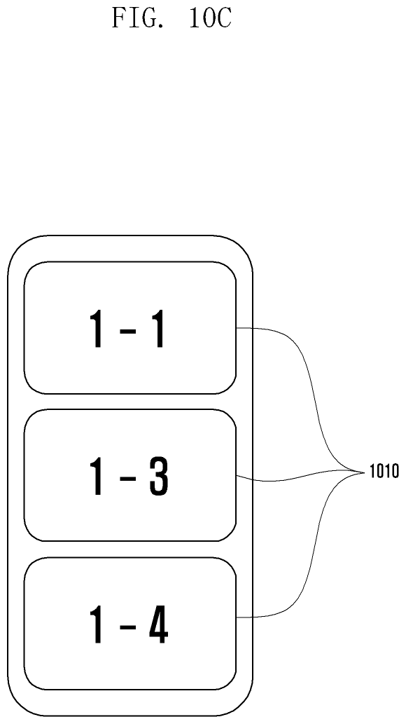

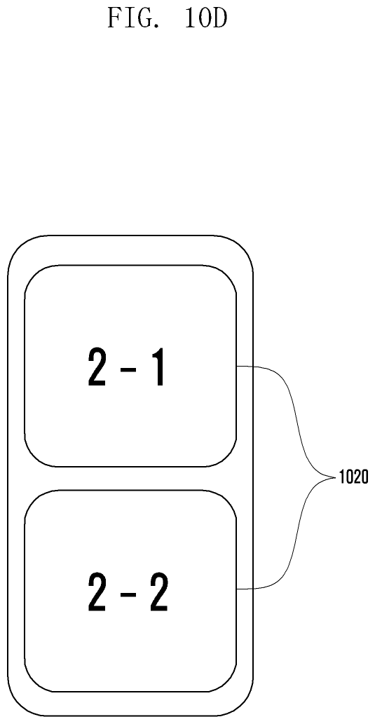

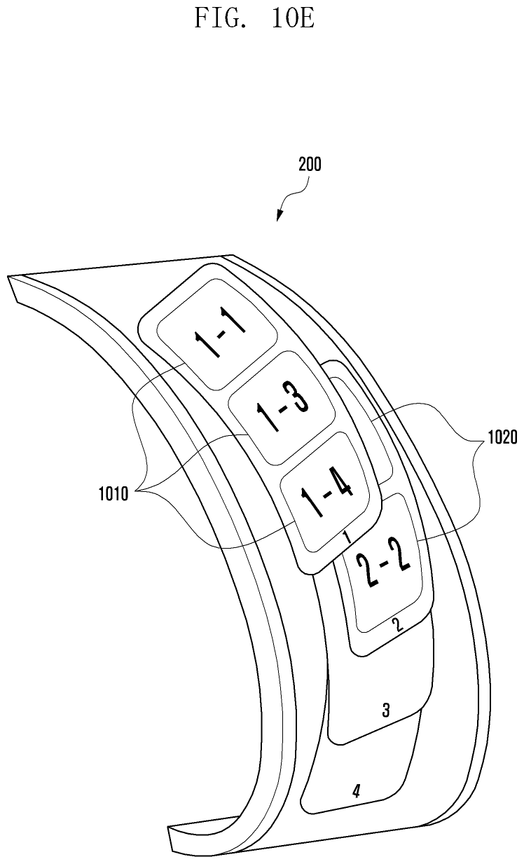

FIG. 10A is a schematic diagram of an embodiment in which the user of a wearable electronic device configures a main application and a main widget according to an embodiment of the disclosure.

FIG. 10B is a schematic diagram of an embodiment in which the order of multiple layers is determined based on the degree of importance configured for a wearable electronic device according to an embodiment of the disclosure.

FIG. 10C is a schematic diagram of an embodiment in which a wearable electronic device generates an unidentified notification included in a first application as a single layer according to an embodiment of the disclosure.

FIG. 10D is a schematic diagram of an embodiment in which a wearable electronic device generates an unidentified notification included in a second application as a single layer according to an embodiment of the disclosure.

FIG. 10E is a schematic diagram of an embodiment in which a wearable electronic device displays a layer generated to respond to an unidentified notification of a first application and a layer generated to respond to an unidentified notification of a second application as a multilayer according to an embodiment of the disclosure.

According to various embodiments of the disclosure, the embodiments disclosed in FIGS. 2A, 2B, 3A, 3B, 4A, 4B, 5A, 5B, 6, 7A, 7B, 8A, 8B, 8C, 8D, 8E, 9A, 9B, 9C, and 9D described above may be applied to the embodiments disclosed in FIGS. 10A to 10E.

Referring to FIG. 10A, the user of the wearable electronic device 200 may select or configure the first application 1010, the second application 1020, the first widget 1030, and/or the second widget 1040 by performing a swipe operation with respect to the display 210.

According to an embodiment of the disclosure, the user of the wearable electronic device 200 may select the first application 1010, the second application 1020, the first widget 1030, and/or the second widget 1040 displayed through a swipe operation regarding the display 210 and may configure the degree of importance of each. For example, the first application 1010 may be configured to have a first degree of importance and/or a first score. For example, the second application 1020 may be configured to have a second degree of importance and/or a second score. For example, the first widget 1030 may be configured to have a third degree of importance and/or a third score. For example, the second widget 1040 may be configured to have a fourth degree of importance and/or a fourth score. For example, the first application 1010 may include a contact-related application that the user frequently uses. For example, the second application 1020 may include a text message-related application that the user frequently checks. For example, the first widget 1030 may include a schedule widget for managing the user's schedule. For example, the second widget 1040 may include a weather widget that provides weather information. According to an embodiment of the disclosure, the wearable electronic device 200 may generate layers corresponding to the first application 1010, the second application 1020, the first widget 1030, and the second widget 1040, respectively, based on degree of importance (e.g., first degree of importance, second degree of importance, third degree of importance, and/or fourth degree of importance) configured by the user.

According to an embodiment of the disclosure, the wearable electronic device 200 may determine the stacking order of layers corresponding to the first application 1010, the second application 1020, the first widget 1030, and the second widget 1040, based on degrees of importance (e.g., the first degree of importance, the second degree of importance, the third degree of importance, and/or the fourth degree of importance) configured by the user. For example, the first degree of importance may have a higher priority for notifying an unidentified notification than the second degree of importance. For example, the second degree of importance may have a higher priority for notifying the unidentified notification than the third degree of importance. For example, the third degree of importance may have a higher priority for notifying an unidentified notification than the fourth degree of importance.

Referring to FIG. 10B, based on degrees of importance (e.g., the first degree of importance, the second degree of importance, the third degree of importance, and/or the fourth degree of importance) configured by the user, an unidentified notification (e.g., a first unidentified notification) of the first application 1010 having the first degree of importance may be generated and/or displayed on the first layer 1 which is positioned topmost among the second multilayer 320. For example, an unidentified notification (e.g., a second unidentified notification) of the second application 1020 having the second degree of importance may be generated and/or displayed on the second layer 2 which is positioned below the first layer 1 of the second multilayer 320. For example, an unidentified notification of the first widget 1030 having the third degree of importance may be generated and/or displayed on the third layer 3 which is positioned below the second layer 2 of the second multilayer 320. For example, an unidentified notification of the second widget 1040 having the fourth degree of importance may be generated and/or displayed on the fourth layer 4 which is positioned below the third layer 3 of the second multilayer 320.

According to an embodiment of the disclosure, the first layer 1, the second layer 2, the third layer 3, and/or the fourth layer 4 may be generated and/or displayed in order according to degrees of importance configured by the user. For example, the first layer 1, the second layer 2, the third layer 3, and/or the fourth layer 4 may be stacked in order according to degrees of importance configured by the user. According to an embodiment of the disclosure, the stacking order of the first layer 1, the second layer 2, the third layer 3, and/or the fourth layer 4 may be determined and/or changed based on ranks or scores corresponding to degrees of importance configured by the user.

According to an embodiment of the disclosure, in case that the user of the wearable electronic device 200 configures the first application 1010 to have a first degree of importance and configures the second application 1020 to have a second degree of importance, the first layer 1 corresponding to the first degree of importance may be positioned above the second layer 2 corresponding to the second degree of importance.

Referring to FIGS. 10C and 10E, in a state where a first unidentified notification 1-1 received through the first application 1010 is generated and/or displayed on the first layer 1, in case that a third unidentified notification 1-3 is received through the first application 1010, the third unidentified notification 1-3 may be generated and/or displayed on the first layer 1. For example, in a state where a first unidentified notification 1-1 received through the first application 1010 is generated and/or displayed on the first layer 1, in case that a third unidentified notification 1-3 is received through the first application 1010, the third unidentified notification 1-3 may be generated and/or displayed on the first layer 1 together with the first unidentified notification 1-1.

According to an embodiment of the disclosure, in a state where a (1-1)^{th} unidentified notification (e.g., a first unidentified notification) received through the first application 1010 is generated and/or displayed on the first layer 1, in case that a (1-3)^{th} unidentified notification (e.g., a third unidentified notification) and a (1-4)^{th} unidentified notification (e.g., a fourth unidentified notification) are received through the first application 1010, the (1-3)^{th} unidentified notification (e.g., the third unidentified notification) and the (1-4)^{th} unidentified notification (e.g., the fourth unidentified notification) may be generated and/or displayed on the first layer 1.

According to an embodiment of the disclosure, in a state where a (1-1)^{th} unidentified notification (e.g., a first unidentified notification) received through the first application 1010 is generated and/or displayed on the first layer 1, in case that a (1-3)^{th} unidentified notification (e.g., a third unidentified notification) and a (1-4)^{th} unidentified notification (e.g., a fourth unidentified notification) are received through the first application 1010, the processor 120 may generate and/or display the (1-1)^{th} unidentified notification (e.g., the first unidentified notification), the (1-3)^{th} unidentified notification (e.g., the third unidentified notification), and the (1-4)^{th} unidentified notification (e.g., the fourth unidentified notification) in a collage type on the first layer 1.

According to an embodiment of the disclosure, in a state where a (1-1)^{th} unidentified notification (e.g., a first unidentified notification) received through the first application 1010 is generated and/or displayed on the first layer 1, in case that a (1-3)^{th} unidentified notification (e.g., a third unidentified notification) and a (1-4)^{th} unidentified notification (e.g., a fourth unidentified notification) are received through the first application 1010, the processor 120 may generate and/or display the (1-1)^{th} unidentified notification (e.g., the first unidentified notification), the (1-3)^{th} unidentified notification (e.g., the third unidentified notification), and the (1-4)^{th} unidentified notification (e.g., the fourth unidentified notification) on the first layer 1 so as to at least partially overlap.

According to an embodiment of the disclosure, in a state where a (1-1)^{th} unidentified notification (e.g., a first unidentified notification) received through the first application 1010 is generated and/or displayed on the first layer 1, in case that a (1-3)^{th} unidentified notification (e.g., a third unidentified notification) and a (1-4)^{th} unidentified notification (e.g., a fourth unidentified notification) are received through the first application 1010, the processor 120 may generate and/or display numerals indicating the number of the (1-1)^{th} unidentified notification (e.g., the first unidentified notification), the (1-3)^{th} unidentified notification (e.g., the third unidentified notification), and the (1-4)^{th} unidentified notification (e.g., the fourth unidentified notification) on the first layer 1.

Referring to FIG. 10D and 10E, in case that a (2-1)^{th} unidentified notification (e.g., a second unidentified notification) and a (2-2)^{th} unidentified notification (e.g., a fifth unidentified notification) are received through the second application 1020, the processor 120 may generate and/or display both the (2-1)^{th} unidentified notification (e.g., the second unidentified notification) and the (2-2)^{th} unidentified notification (e.g., the fifth unidentified notification) on the second layer 2.

According to an embodiment of the disclosure, in a state where a (2-1)^{th} unidentified notification (e.g., a second unidentified notification) received through the second application 1020 is generated and/or displayed on the second layer 2, in case that a (2-2)^{th} unidentified notification (e.g., a fifth unidentified notification) is received through the second application 1020, the processor 120 may generate and/or display the (2-1)^{th} unidentified notification (e.g., the third unidentified notification) and the (2-2)^{th} unidentified notification (e.g., the fifth unidentified notification) in a collage type on the second layer 2.

According to an embodiment of the disclosure, in a state where a (2-1)^{th} unidentified notification (e.g., a second unidentified notification) received through the second application 1020 is generated and/or displayed on the second layer 2, in case that a (2-2)^{th} unidentified notification (e.g., a fifth unidentified notification) is received through the second application 1020, the processor 120 may generate and/or display the (2-1)^{th} unidentified notification (e.g., the third unidentified notification) and the (2-2)^{th} unidentified notification (e.g., the fifth unidentified notification) on the second layer 2 so as to at least partially overlap.

According to an embodiment of the disclosure, in a state where a (2-1)^{th} unidentified notification (e.g., a second unidentified notification) received through the second application 1020 is generated and/or displayed on the second layer 2, in case that a (2-2)^{th} unidentified notification (e.g., a fifth unidentified notification) is received through the second application 1020, the processor 120 may generate and/or display numerals indicating the number of the (2-1)^{th} unidentified notification (e.g., the third unidentified notification) and the (2-2)^{th} unidentified notification (e.g., the fifth unidentified notification) on the second layer 2.

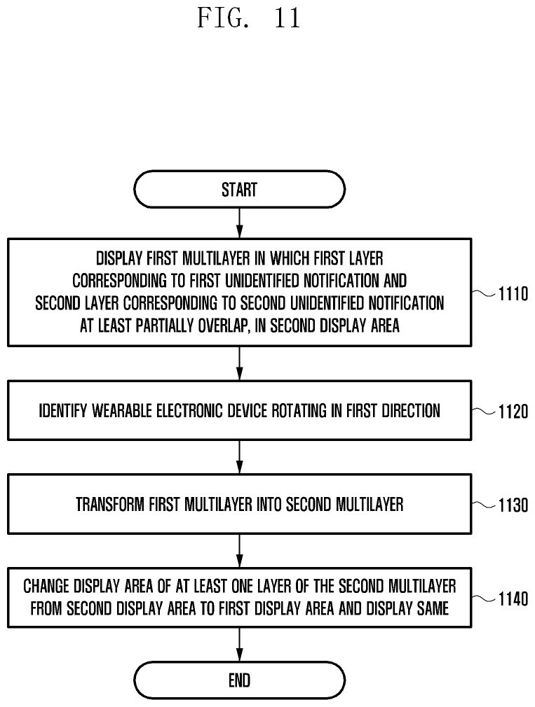

FIG. 11 is a flowchart of a method for controlling a wearable electronic device according to an embodiment of the disclosure.

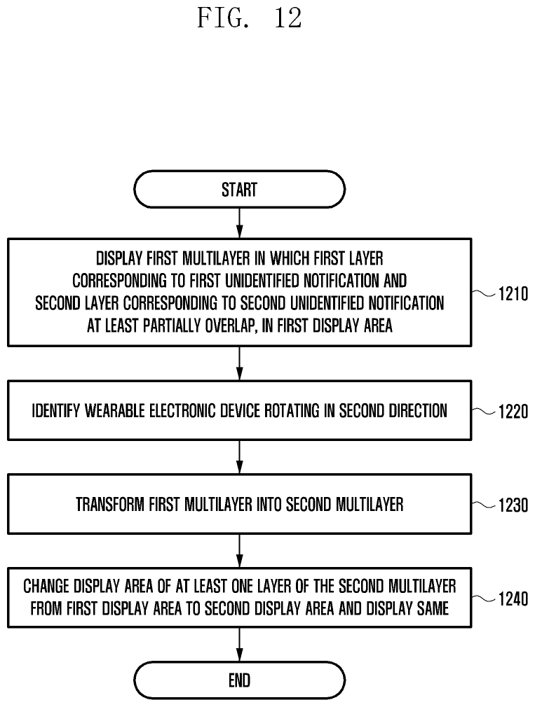

The method disclosed in FIG. 11 may include, for example, the embodiments disclosed in FIGS. 1A, 1B, 2A, 2B, 3A, 3B, 4A, 4B, 5A, 5B, 6, 7A, 7B, 8A, 8B, 8C, 8D, 8E, 9A, 9B, 9C, 10A, 10B, 10C, 10D, and 10E. The method disclosed in FIG. 11 may be integrated and applied to, for example, the embodiments disclosed in FIGS. 2A, 2B, 3A, 3B, 4A, 4B, 5A, 5B, 6, 7A, 7B, 8A, 8B, 8C, 8D, 8E, 9A, 9B, 9C, 10A, 10B, 10C, 10D, and 10E. In the embodiment related to the method disclosed in FIG. 11, respective operations may be performed sequentially, but are not necessarily performed sequentially. For example, the order of respective operations may be changed. For example, the order of respective operations may be performed in parallel. For example, not all of respective operations may be performed, and at least some of them may be performed. The operations disclosed in FIG. 11 may be performed by instructions stored in the processor 120 and/or the memory 130 of the wearable electronic device 200. For example, the method disclosed in FIG. 11 may be integrated with the method disclosed in FIG. 12.

In operation 1110, the wearable electronic device 200 may display a first multilayer 310 in which a first layer 1 corresponding to a first unidentified notification and a second layer 2 corresponding to a second unidentified notification at least partially overlap, in the second display area 212.

According to an embodiment of the disclosure, the first multilayer 310 may include a first size. For example, the first layer 1 and the second layer 2 of the first multilayer 310 may at least partially overlap at a first interval d1.

In operation 1120, the wearable electronic device 200 may identify a rotation in the first direction (\textcircled{1}) (e.g., toward the inside of the user's body) by using the sensor 250.

In operation 1130, the wearable electronic device 200 may transform the first multilayer 310 into the second multilayer 320, based on the rotation in the first direction \textcircled{1} (e.g., inward toward the user's body).

According to an embodiment of the disclosure, the second multilayer 320 may include a second size. For example, the second size may include a larger or wider area than the first size. For example, the first layer 1 and the second layer 2 of the second multilayer 320 may at least partially overlap at a second interval d2.

In operation 1140, the wearable electronic device 200 may change the display area of at least one layer (e.g., the first layer 1) of the second multilayer 320, which was transformed in operation 1130, from the second display area 212 to the first display area 211 and display the same.

According to an embodiment of the disclosure, the wearable electronic device 200 may extend the display area of at least one layer (e.g., the first layer 1) of the second multilayer 320, which was transformed in operation 1130, from the second display area 212 to the first display area 211 and display the same.

According to an embodiment of the disclosure, the wearable electronic device 200 may, based on a rotation in the first direction \textcircled{1} (e.g., toward the inside of the user's body), display the display area of at least one of the first layer 1 and the second layer 2 of the second multilayer 320 transformed in operation 1130 as a glance view changed or extended from the second display area 212 to the first display area 211.

FIG. 12 is a flowchart of a method for controlling a wearable electronic device according to an embodiment of the disclosure.

The method disclosed in FIG. 12 may include, for example, the embodiments disclosed in FIGS. 1A, 1B, 2A, 2B, 3A, 3B, 4A, 4B, 5A, 5B, 6, 7A, 7B, 8A, 8B, 8C, 8D, 8E, 9A, 9B, 9C, 10A, 10B, 10C, 10D, and 10E. The method disclosed in FIG. 12 may be integrated and applied to, for example, the embodiments disclosed in FIGS. 2A, 2B, 3A, 3B, 4A, 4B, 5A, 5B, 6, 7A, 7B, 8A, 8B, 8C, 8D, 8E, 9A, 9B, 9C, 10A, 10B, 10C, 10D, and 10E. In the embodiment related to the method disclosed in FIG. 12, respective operations may be performed sequentially, but are not necessarily performed sequentially. For example, the order of respective operations may be changed. For example, the order of respective operations may be performed in parallel. For example, not all of respective operations may be performed, and at least some of them may be performed. The operations disclosed in FIG. 12 may be performed by instructions stored in the processor 120 and/or the memory 130 of the wearable electronic device 200. For example, the method disclosed in FIG. 12 may be integrated with the method disclosed in FIG. 11.

In operation 1210, the wearable electronic device 200 may display a first multilayer 310 in which a first layer 1 corresponding to a first unidentified notification and a second layer 2 corresponding to a second unidentified notification at least partially overlap, in the first display area 211.

According to an embodiment of the disclosure, the first multilayer 310 may include a first size. For example, the first layer 1 and the second layer 2 of the first multilayer 310 may at least partially overlap at a first interval d1.

In operation 1220, the wearable electronic device 200 may identify a rotation in the second direction \textcircled{2} (e.g., toward the outside of the user's body) by using the sensor 250.

In operation 1230, the wearable electronic device 200 may transform the first multilayer 310 into the second multilayer 320, based on the rotation in the second direction \textcircled{2} (e.g., toward the outside of the user's body).

According to an embodiment of the disclosure, the second multilayer 320 may include a second size. For example, the second size may include a larger or wider area than the first size. For example, the first layer 1 and the second layer 2 of the second multilayer 320 may at least partially overlap at a second interval d2.

In operation 1240, the wearable electronic device 200 may change the display area of at least one layer (e.g., the first layer 1) of the second multilayer 320, which was transformed in operation 1230, from the first display area 211 to the second display a

According to an embodiment of the disclosure, the wearable electronic device 200 may extend the display area of at least one layer (e.g., the first layer 1) of the second multilayer 320, which was transformed in operation 1230, from the first display area 211 to the second display area 212 and display the same.

According to an embodiment of the disclosure, the wearable electronic device 200 may, based on a rotation in the second direction \textcircled{2} (e.g., toward the outside of the user's body), display the display area of at least one of the first layer 1 and the second layer 2 of the second multilayer 320 transformed in operation 1230 as a glance view changed or extended from the first display area 211 to the second display area 212.

A wearable electronic device 200 according to an embodiment of the disclosure may include a sensor 250, a display 210 including a first display area 211 and a second display area 212, memory 130 including one or more recording media for storing instructions, and at least one processor 120 including processing circuitry. According to an embodiment of the disclosure, the instructions, when executed by the at least one processor 120 individually or collectively, may cause the wearable electronic device 200 to display a first multilayer 310 having a first size in which a first layer 1 corresponding to a first unidentified notification and a second layer 2 corresponding to a second unidentified notification at least partially overlap, in the second display area 212, transform the first multilayer 310 into a second multilayer 320 having a second size, based on detecting the wearable electronic device 200 rotating in a first direction, by using the sensor 250, and change a display area of at least one layer among the transformed second multilayer from the second display area 212 to the first display area 211 and display the changed display area.

According to an embodiment of the disclosure, the instructions, when executed by the at least one processor 120 individually or collectively, may cause the wearable electronic device 200 to display the first multilayer 310 in the first display area 211, transform the first multilayer 310 into a second multilayer 320, based on detecting the wearable electronic device 200 rotating in a second direction opposite to the first direction, by using the sensor 250, and change a display area of at least one layer among the transformed second multilayer 320 from the first display area 211 to the second display area 212 and display the changed display area.

According to an embodiment of the disclosure, the instructions, when executed by the at least one processor 120 individually or collectively, may cause the wearable electronic device 200 to configure a first application 1010 having a first degree of importance and a second application 1020 having a second degree of importance, and generate the first layer 1 corresponding to the first degree of importance and the second layer 2 corresponding to the second degree of importance, based on the configured first degree of importance and the second degree of importance. The first unidentified notification may be received through the first application 1010, and the second unidentified notification may be received through the second application 1020.

According to an embodiment of the disclosure, the instructions, when executed by the at least one processor 120 individually or collectively, may cause the wearable electronic device 200 to position the first layer 1 above the second layer 2, based on the configured first degree of importance and the second degree of importance.

According to an embodiment of the disclosure, the instructions, when executed by the at least one processor 120 individually or collectively, may cause the wearable electronic device 200 to, in case that a third unidentified notification is received through the first application 1010 while the first unidentified notification received through the first application 1010 is generated and/or displayed on the first layer 1, generate and/or display the third unidentified notification on the first layer 1.

According to an embodiment of the disclosure, the instructions, when executed by the at least one processor 120 individually or collectively, may cause the wearable electronic device 200 to, in a state where a display area of at least one layer among the transformed second multilayer 320 is changed from the first display area 211 to the second display area 212 and displayed, based on the wearable electronic device 200 rotating in a second direction, transform the second multilayer 320 into the first multilayer 310, based on the wearable electronic device 200 rotating in the first direction within a first designated time, and display the transformed first multilayer 310 in the first display area 211.

According to an embodiment of the disclosure, the instructions, when executed by the at least one processor 120 individually or collectively, may cause the wearable electronic device 200 to, based on the wearable electronic device 200 rotating in the first direction by a threshold value or more while the transformed first multilayer 310 is displayed in the first display area 211, switch a background screen 840 of the wearable electronic device 200 to be displayed instead of the first multilayer 310 displayed on the display 210.

According to an embodiment of the disclosure, the instructions, when executed by the at least one processor 120 individually or collectively, may cause the wearable electronic device 200 to, in a state where a display area of at least one layer among the transformed second multilayer 320 is changed from the first display area 211 to the second display area 212 and displayed, based on the wearable electronic device 200 rotating in the second direction, switch the second layer 2 disposed below the first layer 1 among the second multilayer 320 to be positioned above the first layer 1, based on the wearable electronic device 200 rotating in the first direction within a second designated time.

According to an embodiment of the disclosure, the instructions, when executed by the at least one processor 120 individually or collectively, may cause the wearable electronic device 200 to, in case that the wearable electronic device 200 rotates in the first direction while a state indicator of the wearable electronic device 200 or an icon 710 related to a currently used application is displayed in the second display area 212, further display the state indicator or the icon 710 related to the currently used application in the first display area 211.

According to an embodiment of the disclosure, the instructions, when executed by the at least one processor 120 individually or collectively, may cause the wearable electronic device 200 to, in case that the wearable electronic device 200 rotates in the second direction while a state indicator of the wearable electronic device 200 or an icon 710 related to a currently used application is displayed in the first display area 211, further display the state indicator or the icon 710 related to the currently used application in the second display area 212.

A method for controlling a wearable electronic device 200 according to an embodiment of the disclosure may include an operation of displaying a first multilayer 310 having a first size in which a first layer 1 corresponding to a first unidentified notification and a second layer 2 corresponding to a second unidentified notification at least partially overlap, in a second display area 212. According to an embodiment of the disclosure, the method may include an operation of identifying the wearable electronic device 200 rotating in a first direction, by using a sensor 250. According to an embodiment of the disclosure, the method may include an operation of transforming the first multilayer 310 into a second multilayer 320 having a second size, based on the wearable electronic device 200 rotating in a first direction. According to an embodiment of the disclosure, the method may include an operation of changing a display area of at least one layer among the transformed second multilayer 320 from the second display area 212 to the first display area 211 and displaying the changed display area.

According to an embodiment of the disclosure, the method may include an operation of displaying the first multilayer 310 in the first display area 211, an operation of transforming the first multilayer 310 into a second multilayer 320, based on detecting the wearable electronic device 200 rotating in a second direction opposite to the first direction, by using the sensor 250, and an operation of changing a display area of at least one layer among the transformed second multilayer 320 from the first display area 211 to the second display area 212 and displaying the changed display area.

According to an embodiment of the disclosure, the method may further include an operation of configuring a first application 1010 having a first degree of importance and a second application 1020 having a second degree of importance, and an operation of generating the first layer 1 corresponding to the first degree of importance and the second layer 2 corresponding to the second degree of importance, based on the configured first degree of importance and the second degree of importance. The first unidentified notification may be received through the first application 1010, and the second unidentified notification may be received through the second application 1020.

According to an embodiment of the disclosure, the method may further include an operation of positioning the first layer 1 above the second layer 2, based on the configured first degree of importance and the second degree of importance.

According to an embodiment of the disclosure, the method may further include an operation of, in case that a third unidentified notification is received through the first application 1010 while the first unidentified notification received through the first application 1010 is generated and/or displayed on the first layer 1, generating and/or displaying the third unidentified notification on the first layer 1.

According to an embodiment of the disclosure, the method may further include an operation of, in a state where a display area of at least one layer among the transformed second multilayer 320 is changed from the first display area 211 to the second display area 212 and displayed, based on the wearable electronic device 200 rotating in a second direction, transforming the second multilayer 320 into the first multilayer 310, based on the wearable electronic device 200 rotating in the first direction within a first designated time, and an operation of displaying the transformed first multilayer 310 in the first display area 211.

According to an embodiment of the disclosure, the method may include an operation of, based on the wearable electronic device 200 rotating in the first direction by a threshold value or more while the transformed first multilayer 310 is displayed in the first display area 211, switching a background screen 840 of the wearable electronic device 200 to be displayed instead of the first multilayer 310 displayed on the display 210.

According to an embodiment of the disclosure, the method may include an operation of, in a state where a display area of at least one layer among the transformed second multilayer 320 is changed from the first display area 211 to the second display area 212 and displayed, based on the wearable electronic device 200 rotating in the second direction, switching the second layer 2 disposed below the first layer 1 among the second multilayer 320 to be positioned above the first layer 1, based on the wearable electronic device 200 rotating in the first direction within a second designated time.

According to an embodiment of the disclosure, the method may include an operation of, in case that the wearable electronic device 200 rotates in the first direction while a state indicator of the wearable electronic device 200 or an icon 710 related to a currently used application is displayed in the second display area 212, further displaying the state indicator or the icon 710 related to the currently used application in the first display area 211.

According to an embodiment of the disclosure, the method may include an operation of, in case that the wearable electronic device 200 rotates in the second direction while a state indicator of the wearable electronic device 200 or an icon 710 related to a currently used application is displayed in the first display area 211, further displaying the state indicator or the icon 710 related to the currently used application in the second display area 212.

One or more non-transitory computer-readable recording media storing instructions that, when executed by at least one processor 120 of a wearable electronic device 200 individually or collectively, cause the at least one processor 120 to perform at least one operation. The at least one operation may include an operation of displaying a first multilayer 310 having a first size in which a first layer 1 corresponding to a first unidentified notification and a second layer 2 corresponding to a second unidentified notification at least partially overlap, in a second display area 212 of a display 210, an operation of identifying the wearable electronic device 200 rotating in a first direction, by using a sensor 250, an operation of transforming the first multilayer 310 into a second multilayer 320 having a second size, based on the wearable electronic device 200 rotating in a first direction, and an operation of changing a display area of at least one layer among the transformed second multilayer 320 from the second display area 212 to the first display area 211 and displaying the changed display area.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method of any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A wearable electronic device comprising:
a sensor;
a display including a first display area and a second display area;
memory, comprising one or more storage media, storing instructions; and
at least one processor including processing circuitry communicatively coupled to the sensor, the display, and the memory,
wherein the instructions, when executed by the at least one processor individually or collectively, cause the wearable electronic device to:
display a first multilayer having a first size in which a first layer corresponding to a first unidentified notification and a second layer corresponding to a second unidentified notification at least partially overlap, in the second display area,
transform the first multilayer into a second multilayer having a second size, based on detecting the wearable electronic device rotating in a first direction, by using the sensor, and
change a display area of at least one layer among the second multilayer from the second display area to the first display area and display the changed display area.

2. The wearable electronic device of claim 1, wherein the instructions, when executed by the at least one processor individually or collectively, further cause the wearable electronic device to:
display the first multilayer in the first display area;
transform the first multilayer into a second multilayer, based on detecting the wearable electronic device rotating in a second direction opposite to the first direction, by using the sensor; and
change a display area of at least one layer among the second multilayer from the first display area to the second display area and display the changed display area.

3. The wearable electronic device of claim 1,
wherein the instructions, when executed by the at least one processor individually or collectively, further cause the wearable electronic device to:
configure a first application having a first degree of importance and a second application having a second degree of importance, and
generate the first layer corresponding to the first degree of importance and the second layer corresponding to the second degree of importance, based on the first degree of importance and the second degree of importance, and
wherein the first unidentified notification is received through the first application, and the second unidentified notification is received through the second application.

4. The wearable electronic device of claim 3, wherein the instructions, when executed by the at least one processor individually or collectively, further cause the wearable electronic device to position the first layer above the second layer, based on the first degree of importance and the second degree of importance.

5. The wearable electronic device of claim 3, wherein the instructions, when executed by the at least one processor individually or collectively, further cause the wearable electronic device to, in case that a third unidentified notification is received through the first application while the first unidentified notification received through the first application is generated and/or displayed on the first layer, generate and/or display the third unidentified notification on the first layer.

6. The wearable electronic device of claim 2, wherein the instructions, when executed by the at least one processor individually or collectively, further cause the wearable electronic device to, in a state where a display area of at least one layer among the second multilayer is changed from the first display area to the second display area and displayed, based on the wearable electronic device rotating in a second direction, transform the second multilayer into the first multilayer, based on the wearable electronic device rotating in the first direction within a first designated time, and display the second multilayer in the first display area.

7. The wearable electronic device of claim 6, wherein the instructions, when executed by the at least one processor individually or collectively, further cause the wearable electronic device to, based on the wearable electronic device rotating in the first direction by a threshold value or more while the second multilayer is displayed in the first display area, switch a background image of the wearable electronic device to be displayed instead of the first multilayer displayed on the display.

8. The wearable electronic device of claim 2, wherein the instructions, when executed by the at least one processor individually or collectively, further cause the wearable electronic device to, in a state where a display area of at least one layer among the second multilayer is changed from the first display area to the second display area and displayed, based on the wearable electronic device rotating in the second direction, switch the second layer disposed below the first layer among the second multilayer to be positioned above the first layer, based on the wearable electronic device rotating in the first direction within a second designated time.

9. The wearable electronic device of claim 1, wherein the instructions, when executed by the at least one processor individually or collectively, further cause the wearable electronic device to, in case that the wearable electronic device rotates in the first direction while a state indicator of the wearable electronic device or an icon related to a currently used application is displayed in the second display area, further display the state indicator or the icon related to the currently used application in the first display area.

10. The wearable electronic device of claim 1, wherein the instructions, when executed by the at least one processor individually or collectively, further cause the wearable electronic device to, in case that the wearable electronic device rotates in a second direction while a state indicator of the wearable electronic device or an icon related to a currently used application is displayed in the first display area, further display the state indicator or the icon related to the currently used application in the second display area.

11. A method for controlling a wearable electronic device, the method comprising:
displaying a first multilayer having a first size in which a first layer corresponding to a first unidentified notification and a second layer corresponding to a second unidentified notification at least partially overlap, in a second display area of a display;
identifying the wearable electronic device rotating in a first direction, by using a sensor;
transforming the first multilayer into a second multilayer having a second size, based on the wearable electronic device rotating in a first direction; and
changing a display area of at least one layer among the second multilayer from the second display area to a first display area and displaying the changed display area.

12. The method of claim 11, further comprising:
displaying the first multilayer in the first display area;
transforming the first multilayer into a second multilayer, based on detecting the wearable electronic device rotating in a second direction opposite to the first direction, by using the sensor; and
changing a display area of at least one layer among the second multilayer from the first display area to the second display area and displaying the changed display area.

13. The method of claim 11, further comprising:
configuring a first application having a first degree of importance and a second application having a second degree of importance; and
generating the first layer corresponding to the first degree of importance and the second layer corresponding to the second degree of importance, based on the first degree of importance and the second degree of importance,
wherein the first unidentified notification is received through the first application, and the second unidentified notification is received through the second application.

14. The method of claim 13, further comprising:
positioning the first layer above the second layer, based on the first degree of importance and the second degree of importance.

15. The method of claim 13, further comprising:
in case that a third unidentified notification is received through the first application while the first unidentified notification received through the first application is generated and/or displayed on the first layer, generate and/or display the third unidentified notification on the first layer.

16. The method of claim 12, further comprising:
in a state where a display area of at least one layer among the second multilayer is changed from the first display area to the second display area and displayed, based on the wearable electronic device rotating in a second direction, transform the second multilayer into the first multilayer, based on the wearable electronic device rotating in the first direction within a first designated time, and display the second multilayer in the first display area.

17. The method of claim 11, further comprising:
in case that the wearable electronic device rotates in the first direction while a state indicator of the wearable electronic device or an icon related to a currently used application is displayed in the second display area, further displaying the state indicator or the icon related to the currently used application in the first display area.

18. The method of claim 11, further comprising:
in case that the wearable electronic device rotates in a second direction while a state indicator of the wearable electronic device or an icon related to a currently used application is displayed in the first display area, further displaying the state indicator or the icon related to the currently used application in the second display area.

19. One or more non-transitory computer-readable storage media storing one or more computer programs including computer-executable instructions that, when executed by at least one processor of a wearable electronic device individually or collectively, cause the at least one processor to perform operations, the operations comprising:
displaying a first multilayer having a first size in which a first layer corresponding to a first unidentified notification and a second layer corresponding to a second unidentified notification at least partially overlap, in a second display area of a display;
identifying the wearable electronic device rotating in a first direction, by using a sensor;
transforming the first multilayer into a second multilayer having a second size, based on the wearable electronic device rotating in a first direction; and
changing a display area of at least one layer among the second multilayer from the second display area to a first display area and displaying the changed display area.

20. The one or more non-transitory computer-readable storage media of claim 19, the operations further comprising:
displaying the first multilayer in the first display area;
transforming the first multilayer into a second multilayer, based on detecting the wearable electronic device rotating in a second direction opposite to the first direction, by using the sensor; and
changing a display area of at least one layer among the second multilayer from the first display area to the second display area and displaying the changed display area.
